(19) United States
(12) Patent Application Publication
(10) Pub. No.: US 2015/0304736 A1
(43) Pub. Date: Oct. 22, 2015

(54) TECHNOLOGIES FOR HARDENING THE SECURITY OF DIGITAL INFORMATION ON CLIENT PLATFORMS

(71) Applicants: Reshma Lal, Hillsboro, OR (US); Jason Martin, Beaverton, OR (US); Micah J. Sheller, Hillsboro, OR (US); Michael M. Amirfathi, Chandler, AZ (US); Nathan Heldt-Sheller, Portland, OR (US); Pradeep M. Pappachan, Hillsboro, OR (US)

(72) Inventors: Reshma Lal, Hillsboro, OR (US); Jason Martin, Beaverton, OR (US); Micah J. Sheller, Hillsboro, OR (US); Michael M. Amirfathi, Chandler, AZ (US); Nathan Heldt-Sheller, Portland, OR (US); Pradeep M. Pappachan, Hillsboro, OR (US)

(21) Appl. No.: 14/127,542

(22) PCT Filed: Jun. 4, 2013
(86) PCT No.: PCT/US2013/044158

§ 371 Date: Dec. 19, 2013

(51) Int. Cl. H04N 21/647; H04L 9/08

(52) U.S. Cl. CPC H04N 21/64715; H04L 9/0816; H04L 2209/24

(57) ABSTRACT

Technologies for hardening the security of digital information on a client device are described. In some embodiments, the client device includes a secure processing environment such as a secure enclave, which may be used to protect digital information on a client platform. The secure environment(s) may also protect assets which may be used to access the digital information. Using the secure processing environment(s), the described technologies may protect digital information as it is provided to, stored on, accessed on, and/or processed for display by a client device, even if the client device may be infested with malware or subject to attack by another entity.

### STATEMENT OF GOVERNMENT INTEREST

This disclosure results from research conducted under Joint Development Agreement Numbers FA7000-11-2-0001-0146, FA7000-11-2-0001-0133, FA7000-11-2-0001-0121 and FA7000-11-2-0001-0116 between Intel Corporation and the United States Air Force Academy (USAFA). The government has certain rights in the inventions described herein.

### TECHNICAL FIELD

The present disclosure generally relates to technologies for protecting digital information on client platforms. More particularly, the present disclosure relates to systems and methods for hardening the security of digital information on a client platform, even if the platform is infested with malware or subject to attack by another unauthorized entity.

### BACKGROUND

Over the years, the security of digital information has become increasingly important, particularly when the information has commercial value, is confidential, or relates to a sensitive topic. In some instances digital information may be provisioned on a client device that is infested with malware. If left unchecked, such malware may compromise the security and/or integrity of digital information on the client device. For example, malware may attempt to access and/or obtain digital information from the client itself (e.g., from the client's storage or memory), from the information distribution pathway to the client, and/or from the pathway that enables a user of the client to view or otherwise interact with the digital information. A successful malware attack on any one of those areas may compromise the security of the digital information, and may result in access and/or modification of the information by an unauthorized party.

To increase the security of digital information, enterprise rights management (ERM) and other products have been developed. In many instances ERM products are designed to protect the distribution of sensitive digital information (e.g., documents, electronic mail, and the like) by providing mechanisms for maintaining the integrity and confidentiality of the information, enforcing one or more policies that govern access to the information, and/or by enforcing a logging policy that tracks the usage of digital information on a client.

While existing ERM products are useful, they continue to face security challenges from malware, which may exploit one or more weaknesses in existing ERM products in an attempt to obtain digital information as it is provisioned, stored, and/or used on the client. Authorized users of digital information may also attempt to subvert protections imposed by ERM products, which they may view as inconvenient. Accordingly, there remains a need in the art for technologies that improve the security of digital information as it is provisioned, stored, and/or used on a client platform. The technologies described herein aim to address one or more of these needs.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1A depicts an exemplary digital information security model consistent with the present disclosure.

FIG. 1B, illustrates an exemplary client-server model for implementing the security model of FIG. 1A.

FIG. 2 is a flow diagram depicting high level operations of a digital information protection method consistent with the present disclosure.

FIG. 3 illustrates a block diagram of exemplary system architecture of a client provisioning system consistent with the present disclosure.

FIG. 4 illustrates a messaging flow of an exemplary provisioning method consistent with the present disclosure.

FIG. 5 is a flow diagram of exemplary client operations that may be performed in accordance with a client provisioning method consistent with the present disclosure.

FIG. 6 is a flow diagram of exemplary server operations that may be performed in accordance with a client provisioning method consistent with the present disclosure.

FIG. 7 is a flow diagram of exemplary client operations that may be performed in connection with the establishment of a secure communications channel (session) between a client and server consistent with the present disclosure.

FIG. 8 is a flow diagram of server operations that may be performed in connection with an exemplary secure information transfer method consistent with the present disclosure.

FIG. 9 depicts exemplary system architecture of an ERM system consistent with the present disclosure.

FIG. 10A is a flow diagram of client operations that may be performed in connection with an exemplary secure license distribution method consistent with the present disclosure.

FIG. 10B is a flow diagram of server operations that may be performed in connection with an exemplary secure license distribution method consistent with the present disclosure.

FIG. 11A is a flow diagram of activity logging enforcement operations that may be performed by a client in accordance an exemplary activity logging method consistent with the present disclosure.

FIG. 11B is a flow diagram of server logging operations that may be performed by a server in an exemplary logging method consistent with the present disclosure.

FIG. 12 depicts exemplary system architecture of another ERM system consistent with the present disclosure.

FIG. 13 is a flow diagram of an exemplary temporal secure video encryption key generation method consistent with the present disclosure.

FIG. 14 is a flow diagram of an exemplary method of securing digital information through the display path of a client device consistent with the present disclosure.

Although the following detailed description will proceed with reference being made to illustrative embodiments, many alternatives, modifications, and variations thereof will be apparent to those skilled in the art.

### DETAILED DESCRIPTION

While the present disclosure is described herein with reference to illustrative embodiments for particular applications, it should be understood that such embodiments are exemplary only and that the invention as defined by the appended claims is not limited thereto. Indeed for the sake of illustration the technologies described herein are often discussed in the context of an enterprise rights management (ERM) use model. Such discussions are exemplary only, and it should be understood that all or a portion of the technologies described herein may be used in other contexts. Those skilled in the relevant art(s) with access to the teachings provided herein will recognize additional modifications, applications, and embodiments within the scope of this disclosure, and additional fields in which embodiments of the present disclosure would be of utility.

The technologies described herein may be implemented using one or more devices, e.g., in a client-server architecture. The terms “device,” “devices,” “electronic device” and “electronic devices” are interchangeably used herein to refer individually or collectively to any of the large number of electronic devices that may be used as a client and/or a server consistent with the present disclosure. Non-limiting examples of devices that may be used in accordance with the present disclosure include any kind of mobile device and/or non-mobile device, such as cameras, cell phones, computer terminals, desktop computers, electronic readers, facsimile machines, kiosks, netbook computers, notebook computers, internet devices, payment terminals, personal digital assistants, media players and/or recorders, servers, set-top boxes, smart phones, tablet personal computers, ultra-mobile personal computers, wired telephones, combinations thereof, and the like. Such devices may be portable or stationary. Without limitation, the devices described herein are preferably in the form of one or more cell phones, desktop computers, laptop computers, smart phones and tablet personal computers.

The terms “client” and “client device” are interchangeably used herein to refer to one or more electronic devices that may perform client functions consistent with the present disclosure. In contrast, the terms “server” and “server device” are interchangeably used herein to refer to one or more electronic devices that may perform server functions consistent with the present disclosure.

Many of the FIGS. illustrate exemplary systems in accordance with the present disclosure as including a single client and a single server. Such illustrations are exemplary and any number of clients and servers may be used. Indeed, the technology described herein may be implemented with a plurality (e.g., 2, 5, 10, 20, 50, 100 or more) of client and/or server devices. Thus, while the present disclosure may refer to a client and/or a server in the singular, such expressions should be interpreted as also encompassing the plural form. Similarly, the designation of a device as a client or server is for clarity, and it should be understood that client devices may be configured to perform server functions, and that server devices may be configured to perform client functions consistent with the present disclosure.

The term “digital information” is used herein to refer to content such as audio, video, imagery, text, markup, pictures, metadata, hyperlinks, source code, enterprise rights management (ERM) software, other software, licenses, encryption and/or decryption keys, authentication credentials, digital signature keys, access policies, other data, combinations thereof, and the like, which may be stored in digital form in a computer readable medium.

The terms “distributor” and “source” are interchangeably used herein to refer to a device or other entity that is capable of transferring digital information, e.g., to a client, a server, or a combination thereof. In some embodiments, a distributor/source may be in the form of an electronic device or storage medium that transfers digital information. For example, a distributor may be a third party device, a storage medium such as a flash memory device, a thumb drive, an optical disc, etc., combinations thereof, and the like. Alternatively or additionally, a server may act as a distributor of digital information. In any case, a distributor may provide digital information to another device (e.g., a client) in any suitable manner, such as via wired or wireless transmission.

As used in any embodiment herein, the term “module” may refer to software, firmware and/or circuitry configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more devices, as defined previously.

The phrase “close range communication” is used herein to refer to technologies for sending/receiving data signals between devices that are relatively close to one another, i.e., via close range communication. Close range communication includes, for example, communication between devices using a BLUETOOTH™ network, a personal area network (PAN), near field communication, a ZigBee network, a wired Ethernet connection, combinations thereof, and the like. In contrast, the phrase “long range communication” is used herein to refer to technologies for sending/receiving data signals between devices that are a significant distance away from one another, i.e., using long range communication. Long range communication includes, for example, communication between devices using a WiFi network, a wide area network (WAN) (including but not limited to a cell phone network (3G, 4G, etc. and the like), the internet, telephony networks, combinations thereof, and the like.

The present disclosure generally relates to technologies for hardening the security of digital information on client devices. More particularly, the technologies of the present disclosure may be configured to protect the security and/or integrity of digital information as it is provided to a client, stored on a client, accessed by a client, displayed on a client, or a combination thereof. In some embodiments the technologies described herein may maintain the security and/or integrity of digital information on a client device, even if the client device is infested with malware or subject to attack by another entity.

Before discussing aspects of the present disclosure in detail, it may be useful to understand the nature of various threats that may affect the security of digital information as it is provisioned, stored, and used on a client device. The present disclosure will therefore initially describe various threats to digital information in the context of a digital information security model. Various aspects of the present disclosure will then be described.

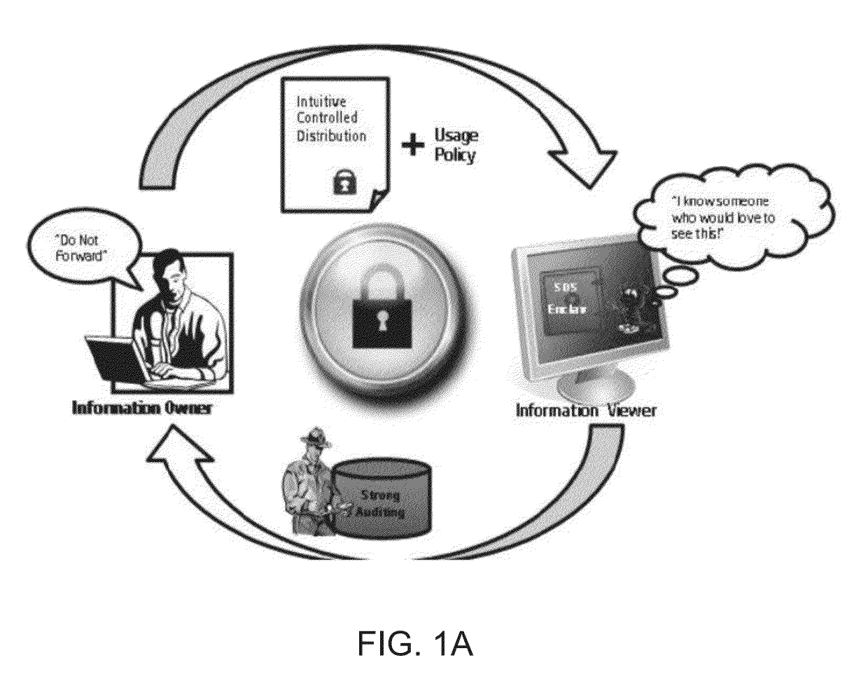

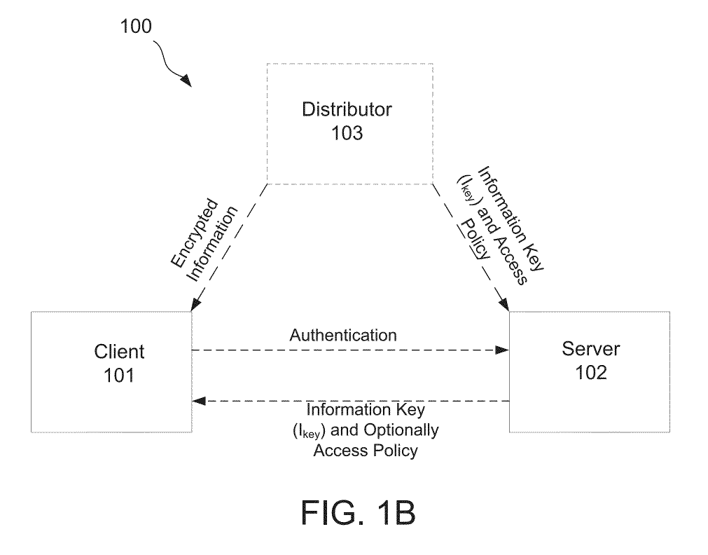

FIG. 1A depicts an exemplary digital information security model consistent with the present disclosure. In this model, an owner of digital information (e.g., a distributor) may wish to securely provide the information to an information viewer (e.g., a client). To protect the information, the model may have several security objectives, including but not limited to: reducing the exposure of digital information to malware; controlling the distribution of digital information to only authorized client devices; enforcing an information access policy that controls how digital information may be used; enforcing an activity logging policy that tracks the usage of digital information, e.g., for audit and/or non-repudiation purposes; and combinations thereof. The security model of FIG. 1A may therefore be understood as an enterprise rights management (ERM) security model. In the model of FIG. 1A and as further described in FIG. 1B, the information owner may attempt to achieve these objectives by controlling distribution of the digital information to authorized viewers, imposing a usage policy on the distributed information, by requiring strong auditing over access and use of the distributed information by the information viewer, or some combination thereof.

FIG. 1B, illustrates an exemplary client-server model for implementing the security model of FIG. 1A. As shown, system 100 includes client 101, server 102, and optional distributor 103. In general, client 101 may be used to consume digital information that it receives from a source, such as optional distributor 103 or another entity such as server 102. For the sake of illustration, FIG. 1B illustrates a system wherein optional distributor 103 provides digital information to client 101.

Optional distributor 103 may be the owner/creator of digital information, and may wish to securely share such information with client 101. However, optional distributor 103 may not trust client 101, and may be unaware of the security of the environment client 101 may provide for the storage and processing of digital information. Optional distributor 103 may therefore wish to enforce a security model such as the one shown in FIG. 1A to protect digital information that may be provided to client 101.

Accordingly, optional distributor 103 may protect the digital information prior to providing it to client 101. For example, optional distributor 103 may use a first encryption protocol to encrypt the digital information prior to providing it to client 101. Non-limiting examples of suitable first encryption protocols include single (e.g., shared) key encryption protocols, symmetric key encryption protocols, asymmetric key (e.g., public key) encryption protocols, combinations thereof and the like. In some embodiments, optional distributor 103 may encrypt the digital information with an information encryption key (I_{key}) using a single key encryption protocol. Thus in the non-limiting embodiment of FIG. 1B, optional distributor 103 (or another source) may use I_{key} to convert the plaintext of digital information into cipher text. In instances where server 102 acts as a source, it may be understood that server 102 may protect digital information in a similar manner prior to providing the digital information to client 101.

The encrypted digital information may be provided to client 101 in any suitable manner. For example, optional distributor 103 may transmit the encrypted digital information to client 101 via wired or wireless communication using one or more pre-determined communications protocols. This concept is shown in FIG. 1B, wherein encrypted digital information is shown as being transmitted from optional distributor 103 to client 101. Alternatively or additionally, optional distributor 103 may transmit encrypted digital information to server 102 (with which it may have a pre-established trusted relationship), and server 102 may then provide the encrypted information to client 101. The encrypted digital information may also be provided to client 101 via a data storage medium such as a thumb drive, universal serial bus (USB) key, a non-volatile memory device, combinations thereof, and the like.

The encrypted digital information may be further protected with a license specified by optional distributor 103 or another source such as server 102 or a third party device (not shown). The license may include an information access policy that includes one or more control parameters that govern access to the encrypted information and/or its plaintext. For example, the control parameters may specify when the encrypted information may be accessed, which clients may access the information (client identification), which users may access the information (user identification), the length of time the information may be accessed, whether the information may be modified, combinations thereof, and the like.

The license may also include one or more keys that may be used to decrypt the encrypted digital information on client 101 using a decryption protocol that is suitable for decrypting information that was encrypted with the first encryption protocol. For example when the digital information has been encrypted using and a single key encryption protocol, a license to the digital information may include a copy of I_{key}, either alone or in combination with an information access policy. In that case, Client 101 may use I_{key} to decrypt digital information using a decryption suitable for decrypting information encrypted with a single key encryption protocol.

The license may be generated by or provided to server 102. This concept is shown in FIG. 1B, in which optional distributor 103 provides server 102 with a license that includes a copy of an I_{key} that was used to encrypt the digital information provided to client 101, as well as an information access policy governing such information.

Client 101 may include one or more modules stored thereon. For example, client 101 may include a client enterprise rights enforcement module (CEREM) stored in a memory thereof. The CEREM may be used to perform enterprise rights management (ERM) or other operations on the cipher and/or plaintext of digital information. In the context of FIG. 1B, the CEREM when executed may cause client 101 to attempt to access encrypted digital information provided by optional distributor 103. Because client 101 may initially lack knowledge of the encryption key(s) used to encrypt the digital information (e.g., I_{key}), it may initially be unable to decrypt the encrypted digital information. In such instances the CEREM when executed may cause client 101 to attempt to obtain a copy of a license containing I_{key}, e.g., from server 102.

Server 102 may condition the distribution of a license on the successful authentication of client 101. In this regard, the CEREM when executed may cause client 101 to transmit authentication credentials to server 102. Such credentials may include one or more identifying indicia, such as but not limited to client 101's platform identifier, a username and/or password of a user of client 101, identification information for the ERM module executed on client 101, combinations thereof, and the like. Server 102 may analyze the authentication credentials received from client 101, and attempt to authenticate client 101, e.g., against the access policy received from distributor 103, a pre-established list of trusted platforms (e.g., a whitelist), combinations thereof, and the like.

If server 102 successfully authenticates client 101, it may transmit all or a portion of the license governing the digital information to client 101, including any pertinent key(s). For example server 102 may transmit a license including I_{key} to client 101, either alone or in combination with the information access policy governing the digital information provided to client 101, as generally shown in FIG. 1B. If an access policy is transmitted, it may be enforced by a policy enforcement module (PEM), which may be included in or separate from the CEREM. If the access policy permits, client 101 may access and use keys provided with the license (e.g., I_{key}) to decrypt the encrypted digital information.

The PEM on client 101 may also enforce an event logging policy, which may be included in or separate from an information access policy. In such instances the PEM when executed may cause client 101 to record activity associated with specified digital information. For example, the PEM when executed may cause client 101 to record failed/successful attempts to access, modify, and/or delete the encrypted digital information or its corresponding plaintext. Such events may be recorded in association with the time the event occurred, and may be stored in a log within a memory of client 101.

FIG. 1B depicts a system wherein optional distributor 103 is the source of encrypted information, I_{key} and an access policy governing the encrypted information. This illustration is exemplary only, and it should be understood that another device or entity may provide these components. For example, server 102 or another device may include a document store that includes the plaintext of digital information that will be sent to client 101. In such instances, server 102 may perform the functions of distributor 103 discussed above, e.g., by encrypting the digital information (e.g., with a first encryption protocol) and transmitting the encrypted information, licenses, etc. to client 101. Optional distributor 103 may therefore be omitted from system 100.

FIG. 1B also depicts a system in which client 101, server 102 and distributor 103 may directly communicate with one another. While direct communication between such devices is useful, it is not required. Indeed, system 100 may be configured such that client 101, server 102, and distributor 103 are capable of communicating with one another via a network (not shown). Such network may be any type of network that is capable of transferring data between client 101, server 102, and distributor 103. Non-limiting examples of such networks include long range communication networks, close range communication networks, and combinations thereof.

Regardless of the manner in which the components of system 100 communicate, client 101 may be infested with malware or subject to other security flaws which if left unaddressed may jeopardize the security and/or integrity of digital information provided to client 101. For example, malware may attempt to subvert the mechanism by which client 101 authenticates itself to server 102, e.g., by obtaining copies of client 101's authentication credentials. In some existing ERM systems, client authentication credentials may be stored in unprotected memory of a client. Malware or other malicious entities may therefore be able to attack the memory of the client in an attempt to obtain such credentials. If successful, the malware may obtain the client's credentials and use them to impersonate an authorized system, user, and/or application, potentially spoofing server 102 into transmitting document encryption key(s) (e.g., I_{key}) and/or a relevant access policy to it.

Malware may also attempt to steal the information encryption key(s) used to encrypt digital information provisioned to a client (e.g., I_{key}). In this regard, strong cryptographic protocols exist for protecting encryption keys as they are in transit to and stored on a client. For example, an I_{key} may itself be encrypted (e.g., using a key encryption key (KEK)) while it is in transit to and stored on a client. In such instances the information access policy enforced by a client or server may include one or more keys which may be used to decrypt the encrypted I_{key}, and may condition the distribution of such keys on successful attestation and/or validation of the client. Although these mechanisms can protect I_{key} while it is transmitted and stored on a client, the plaintext of I_{key} may be stored in unprotected memory of a client while it is in use. Malware or another entity may therefore be able to access the plaintext of I_{key} as it is used by a client to decrypt encrypted digital information.

Malware may also attempt to steal the plaintext of digital information as it is used on a client device. Like encryption keys, strong cryptographic mechanisms exist to protect digital information as it is transmitted to and stored on a client device. When the client wishes to use the information however, it may decrypt the information and store the plaintext in unprotected memory. At that time the plaintext of the digital information may be susceptible to theft by malware or another unauthorized entity.

The plaintext of digital information may also be susceptible to theft by malware as it is processed through the display path of the client device. For example, raw (unencrypted) “pages” or “frames” of the plaintext of the digital information may be transmitted to unsecure memory within the media (e.g., audio and/or video) hardware of the client device. In such instances, malware or other entities may be able to steal or otherwise gain access to the raw frames, e.g., by pilfering the media (e.g. video) memory, a “screen-scraping” attack, combinations thereof, and the like.

Malware or another entity may also attempt to tamper with or subvert an information access policy that governs the use of digital information on a client. For example, existing ERM solutions may store information access policies in unsecured memory of a client device. Malware and/or users of client 101 may therefore be able to attack such policies, e.g., to alter and/or eliminate restrictions that may be imposed by the policy on relevant digital information. For example, an information access policy may impose a time limit on access to digital information. In such instances, malware or a user of client 101 may attempt to modify the policy to extend or remove the time limit set by the policy. Alternatively or additionally, an access policy may limit access to digital information to specific users of client. In such instances, malware or another entity may attempt to modify an access policy to insert additional (e.g., non-authorized) users into the list of authorized users, potentially allowing the added users to access digital information that they may not have otherwise been able to access.

In some existing ERM solutions logging components and event logs may be stored in unsecured memory within a client device. Malware and other entities may be thus able to access and tamper with the logging components and/or event logs for various purposes. For example, malware may attempt to tamper with a logging component in an effort to deactivate or modify logging activities. Similarly, malware may attempt to modify logs produced by the execution of a logging module, e.g., to hide its unauthorized access to protected digital information.

In sum, client devices may be subject to attacks from malware, end users, and other entities, which may aim to subvert or gain unauthorized access to digital information stored on the client device, and/or assets that may be used to gain unauthorized access to such information. As will be described below, the technologies of the present disclosure may harden the security of digital information and other assets on a client device, so as to hinder, thwart, or prevent unauthorized access to such information and assets.

Generally, the technologies of the present disclosure utilize client devices that include one or more secure processing environments. These environments may function to harden the security of digital information on a client device, e.g., by protecting the plaintext of the digital information as well as assets that may be utilized to gain unauthorized access to the digital information. More particularly, such environments may provide a secure location for the storage and/or execution of assets (e.g., digital information, encryption keys, client authentication information, modules, etc.) that may be used in a digital information security model, such as the protection model described above in connection with FIGS. 1A and B. For example, such environment(s) may provide a secure location for the storage, execution, and use of the plaintext of digital information, the plaintext of information encryption keys (I_{key}) used to encrypt digital information, client authentication credentials, licenses governing access to digital information, various modules for enterprise rights management, logging policy enforcement, access policy enforcement, combinations thereof, and the like.

Memory enclaves are one example of a secure processing environment that may be used in the client devices of the present disclosure. A memory enclave is made up of at least one memory page that has a different access policy than the access policy imposed by traditional ring boundaries of a computing device. The memory page(s) within a memory enclave may have associated read/write controls which may be configured such that the read/write controls have exclusivity over certain operating modes or privilege “rings”, system management mode or virtual machine monitors of an associated processor. A memory enclave may therefore be designed to provide a sheltered place to host and execute trusted code, data, and the like such that it may be protected from other software on a client, including application software and privileged software such as an operating system, a virtual machine monitor, combinations thereof, and the like. It should be understood that the terms “memory enclave” and “secure enclave” are used interchangeably in the context of the present disclosure. Without limitation, suitable memory enclaves include those provided using INTEL™ secure enclave technology. Of course, other suitable memory enclave technologies may be used.

Tampering with the contents of a memory enclave may be detected using a measurement of the enclave. For example, a client, server or another entity may have knowledge of the measurement of a valid memory enclave. Modification of the code/data in the enclave may result in a detectable change to the enclave measurement, which may be considered evidence of tampering. In such instance, transfer of digital information or other data to the enclave may be prevented.

Memory enclaves consistent with the present disclosure may also be configured to provide a mechanism by which their identity and/or integrity may be attested to a server and/or other components of the client. For example, a memory enclave on a client may be configured such that it may request an enclave report from client hardware. The enclave report may include various information such as the enclave's identifying information (“enclave ID”), a measurement of the code and data stored in the enclave, the enclave's security version number (SVN), the identity of an independent software vendor (ISV) that may have provisioned the enclave on the client, combinations thereof, and the like. The report may also include other information such as the user name(s) of authorized user(s) of the client, the client's machine (platform) identifier, other identifying indicia (e.g., application specific identification indicia), combinations thereof, and the like.

The enclave report may be signed with a digital signature using a first digital signature protocol, such as the Rivest Shamir Adleman (RSA) signature protocol, the digital signature algorithm (DSM) protocol, Intel Enhanced Privacy Identification (EPID), combinations thereof and the like. For example, a module may cause an enclave to sign an enclave report a signing key that is specific to the enclave, such as but not limited to an enclave signing key, an independent software vendor (ISV) key, combinations thereof, and the like. A quoting module local to or remote from the client may verify the integrity of the signed report by verifying the authenticity of the digital signature applied thereto. Upon verification of the digital signature applied to the enclave report, the quoting module may generate an enclave quote and sign the quote with a quote signing key using a second digital signature protocol that is the same or different from the first digital signature protocol. The quote signing key may be specific to the client, such as the client's EPID key, the client's platform key, another signing key specific to the client, combinations thereof, and the like.

The signed enclave quote may allow a remote device (e.g., a server) to verify the authenticity and/or integrity of a memory enclave and the contents (code and data) of the memory enclave on a client. In particular, the enclave quote may allow a remote entity (e.g., server 102) to have proof that an enclave is genuine, e.g., by providing proof that no one else but the relevant enclave (or corresponding processor) could have generated the report, and by providing information that allows the remote entity to verify that the code and data inside the enclave has not been modified. For example, a server may authenticate a memory enclave by verifying that the enclave is running on a trusted platform, checking the enclave measurement and/or identity information included in the enclave quote, combinations thereof, and the like. As will be discussed below, successful verification of the memory enclave may facilitate the provisioning of initial secrets to the enclave from the server. This mechanism may also be used by one enclave on the client to verify the integrity of another enclave on the client, thus allowing two or more client enclaves to collaborate to perform operations consistent with the present disclosure.

The memory enclaves described herein may also be configured to allow data to be sealed to the enclave. In some embodiments, data may be sealed to a memory enclave using a sealing protocol. In some embodiments, the sealing protocol seals the data to an enclave by encrypting it with an enclave sealing key, which may be stored within the enclave or in another secure location. Because the enclave that sealed the data may be the only entity with knowledge of the enclave sealing key, it may be the only entity capable of unsealing the data.

Another example of a secure processing environment that may be used in the clients of the present disclosure is a trusted execution environment (TEE). In general, a TEE is a secure environment that runs alongside an operating system and which can provide secure services to that operating system. More information regarding TEEs and the implementation thereof may be found in the TEE client application programming interface (API) specification v1.0, the TEE internal API specification v1.0, and the TEE system architecture v1.0 issued by GlobalPlatform. In some embodiments, a TEE may be provided using one or more of virtualization technology and security co-processor technology. Non-limiting examples of such technology include INTEL™ VT-x virtualization technology, INTEL™ VT-d virtualization technology, INTEL™ trusted execution technology (TXT), converged security engine (CSE) technology, converged security and manageability engine (CSME) technology, a security co-processor, manageability engine, trusted platform module, platform trust technology, ARM TRUSTZONE® technology, combinations thereof, and the like. The nature, advantages and limitations of each of these technologies are well understood, and therefore are not described herein. In some embodiments of the present disclosure, a TEE on a client may be used to provide a trusted source of time, e.g., when the client may not have access to a trusted source of time from a trusted remote entity. In other words, a TEE may be used as a local trusted source of time, which may be useful for secure logging, secure video, and other processes consistent with the present disclosure.

The client devices and methods of the present disclosure may also utilize protected audio video (PAV) technology to maintain the security and/or integrity of the plaintext of digital information as it is processed in the video pathway of the client. In general, PAV technology may be configured to protect audio and/or video information in transit between an application's memory on the client and one or more video/audio devices.

In some instances, the PAV technology utilizes a secure video encryption key (SVEK) to encrypt audio and/or video data inside an application, which may be executed from within a memory enclave. For example, an application may encrypt media (e.g., audio/video) information using, a shared secret key (e.g., SVEK) which may be known to the client's media hardware and may be stored in a secure processing environment, such as a memory enclave. The encrypted media information may be conveyed to and stored in the media (e.g., audio/video) buffer of the client's media hardware. When the audio/video information is to be displayed, it may be decrypted by the client's media hardware using the SVEK. The resulting raw audio/visual information may be then be encoded into an encrypted audio visual signal, such as a high-bandwidth digital content protection (HDCP) signal, which may protect the raw audio visual information as it is transmitted from a client to a display.

Any suitable PAV technology may be used in the client devices of the present disclosure, provided that it can protect the plaintext and/or raw frame forms of digital information as it is processed through the display pathway of a client. As one example of such technology, mention is made of INTEL™ protected audio video path (PAVP) technology. Of course, other forms of PAV technology may be used. In some embodiments, the PAV technology may be implemented using media (e.g., video) hardware which is integrated into a motherboard of a client, the processor of a client, or a combination thereof, i.e., using integrated graphics. Alternatively or additionally, the PAV technology described herein may be implemented using one or more discrete graphics adaptors, which may be coupled or otherwise connected to a motherboard of a client.

The present disclosure will now describe systems and methods for hardening the security of digital information provided to a client that is equipped with one or more secure enclaves, trusted execution environments, PAV technology, and combinations thereof. As will become clear from the following discussion, the technology may be used to protect the security and integrity of digital information as it is provided to, stored on, accessed by, and/or displayed on a client.

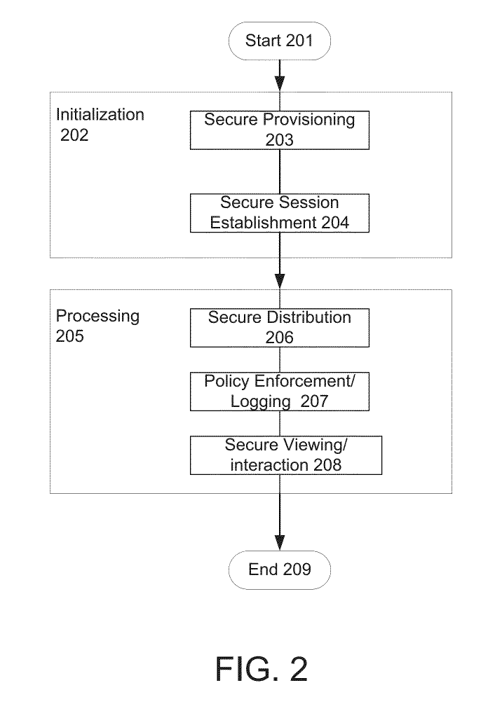

FIG. 2 is a flow diagram depicting high level operations of a digital information protection method consistent with the present disclosure. As shown, the method begins at block 201. At block 202, secure initialization operations may be performed between a client and a server. Such operations may include secure provisioning operations 203 and secure session establishment operations 204, each of which will be described in detail later. In general, secure provisioning operations 203 may result in the secure provisioning of initial secrets on a client and a server. Those secrets may be later used to authenticate the client to the server, e.g., in association with a request for assets such as a license to digital information stored on the client. Such secrets may also be leveraged pursuant to block 204 to establish a secure communications session between the client and server.

Once a secure session has been established between a client and a server, the method may proceed to processing block 205, wherein various secure processing operations may be performed. The secure processing operations may include secure distribution operations 206, policy enforcement/logging operations 207, and secure viewing/interaction operations 208. In general, secure distribution operations 206 may include operations that result in the secure storage of encrypted digital information on a client, as well as assets that may govern access to the encrypted digital information. Policy enforcement/logging operations 207 may generally include operations that protect and enforce access and/or logging policies that may be imposed on digital information stored on the client. Secure viewing/interaction operations 208 may generally include operations that protect the security and integrity of digital information on a client as it is used and/or output for display. Once secure viewing/interaction operations 208 are complete, the method may proceed to block 209 and end. Although the method of FIG. 2 depicts blocks 206-208 as being performed in succession, it should be understood that operations pursuant to such blocks may be performed in any order, and may be performed independently of each other.

As noted above, malware resident on a client may attempt to steal or gain access to assets that may be leveraged to obtain digital information stored on the client. Such assets may include the client's authentication credentials and/or other secrets which may be provisioned on the client for authentication, secure session establishment, another purpose, or a combination thereof. Accordingly, one aspect of the present disclosure relates to technologies for securely provisioning and storing secrets on a client device. As will be described below, such technologies may utilize the capabilities of memory enclave technology to securely provision initial secrets on a client device and to establish the identity of the client to a server. Once the initial secrets and client identity have been provisioned, they may be used to establish a secure communication session (“channel”) for subsequent communication between the client and the server.

As used herein, the term “provisioning” refers to processes by which a client establishes its identity with a server, and stores that identity and other credentials locally in a secured fashion for subsequent communication with the server. Accordingly, provisioning may be understood as an initialization step that may occur before, during, or after digital information, modules, etc. are provided on a client device.

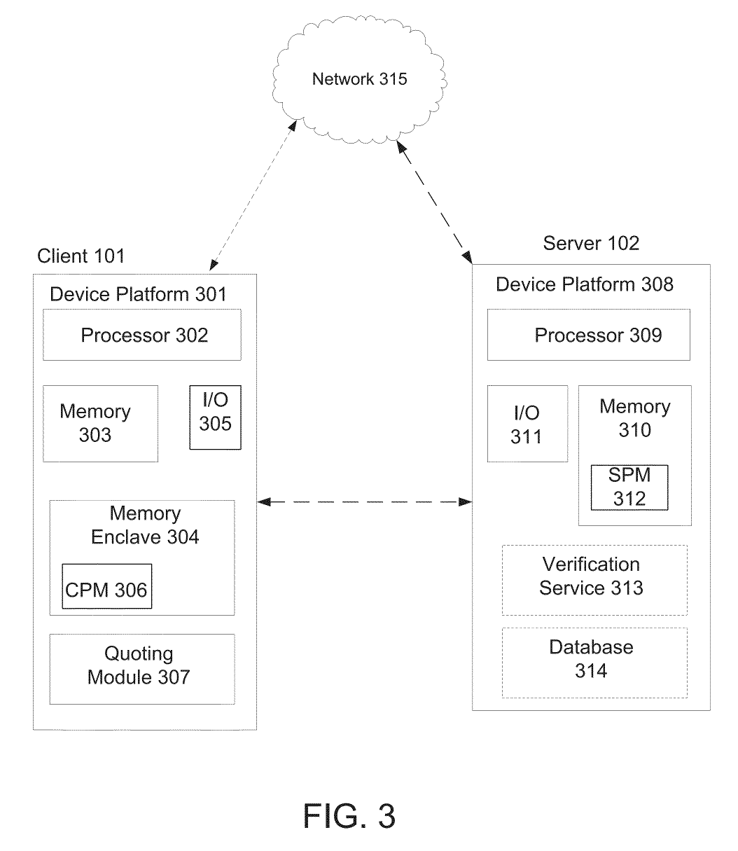

FIG. 3 illustrates a block diagram of exemplary system architecture of a client provisioning system consistent with the present disclosure. As shown, the system includes client 101 and server 102. Client 101 and server 102 may communicate directly or indirectly using network 315, which may be a short range communications network, a long range communications network, or a combination thereof.

Client 101 and server 102 respectively include device platforms 301, 308. Without limitation, device platforms 301, 308 may correlate to one or more of the device types previously discussed above as being suitable for use as a client or server consistent with the present disclosure.

Client 101 and server 102 may further respectively include processors 302, 309. Such processors may be any suitable general purpose processor or application specific integrated circuit, and may be capable of executing one or multiple threads on one or multiple processor cores. Without limitation, processors 302, 309 are preferably general purpose processors, such as but not limited to the general purpose processors commercially available from INTEL™ Corp., ADVANCED MICRO DEVICES™, ARM™, NVIDIA™, APPLE™, and SAMSUNG™. While FIG. 3 illustrates client 101 and server 102 as each including a single processor, multiple processors may be used.

Client 101 and server 102 may also respectively include memories 303, 310, which may be any suitable type of computer readable memory. Exemplary memory types that may be used as memory 303 and memory 310 include but are not limited to: semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally or alternatively, memories 303, 310 may include other and/or later-developed types of computer-readable memory.

Client 101 may be further configured to provide enhanced security for the provisioning and storage of trusted data, code, modules and other information, including but not limited to client authentication credentials. Client 101 may therefore include memory enclave 304, which may function to provide a secure environment for the storage and processing of digital information. As shown in FIG. 3 memory enclave 304 may be present in client 101 as an independent component, e.g., within an independent memory module. Alternatively or additionally, memory enclave 304 may be present within memory 303, in which case all or a portion of memory 303 may be configured as a memory enclave. While a single memory enclave 304 is shown in FIG. 3, it should be understood that client 101 may include multiple memory enclaves. For example, client 101 may include an additional memory enclave (e.g., a quoting enclave, not shown), which may be provided within memory 303 or another memory of client 101, such as a memory local to processor 302.

Client 101 and server 102 may also respectively include input/outputs (I/O) 305 and 311.

I/O 305 may include hardware (i.e., circuitry), software, or a combination of hardware and software that is configured to allow client 101 to transmit and receive communications to and from server 102 and, where applicable, a distributor of digital information (e.g., distributor 103). Likewise, I/O 311 may include hardware (i.e., circuitry), software, or a combination of hardware and software that is configured to allow server 102 to send and receive communications to and from client 101 and, where applicable, a distributor of digital information. In some embodiments, I/O 305 and 311 may include one or more communications modules that enable client 101 and server 102 to communicate with one another.

Communication between I/O 305 and I/O 315 may occur over a wired or wireless connection using a close and/or long range communications network. Such communication may comply with a predefined communications protocol, such as a BLUETOOTH™ protocol, near field communication protocol, any or the wireless 802.11 communications protocols in force on or before the effective filing date of the present disclosure, or a combination thereof. I/O's 305, 311 may therefore include hardware to support such communication, e.g., one or more transponders, antennas, BLUETOOTH™ chips, personal area network chips, near field communication chips, combinations thereof, and the like.

I/O's 305, 311 may also be configured to receive information (e.g., digital information, license policies, etc.) from a data storage medium such as a magnetic recording medium, optical recording medium, magneto-optical recording medium, a solid state (FLASH) recording medium, combinations thereof, and the like. In such instances, I/O's 305, 311 may be configured to permit the receipt of diverse content via such data storage devices.

Client 101 and server 102 may further include client provisioning module (CPM) 306 and server provisioning module (SPM) 312, respectively. CPM 306 may be stored and executed within the context of memory enclave 304 and thus protected from malware and other malicious entities that may be resident on client 101.

In FIG. 3 it is assumed that server 102 is secure and is not subject (or is impervious to) attack from malware. Accordingly, SPM 312 is illustrated as stored within memory 310 of server 102, e.g., in general unsecured memory. Such illustration is exemplary only, and SPM 312 may be stored and/or executed in another environment within server 102. For example, server 102 may itself include a memory enclave (not shown), in which case SPM 312 may be stored within such enclave and protected from malware and other entities that may be resident on server 102.

CPM 306 and SPM 312 may include computer readable instructions which may be executed by processors 302 and 309 respectively, or by another processor. In the case of CPM 306, the CPM instructions may be executed within memory enclave 304. In any case, execution of CPM instructions may cause client 101 and/or service provider 102 to perform secure provisioning operations consistent with the present disclosure. Client 101 may also include quoting module 307, which may include computer readable instructions that when executed (e.g., by processor 302) may cause client 101 to perform enclave report verification operations and enclave quote generation operations consistent with the present disclosure. Quoting module 307 may be stored and executed within memory enclave 304, or may be stored and executed in another (quoting) enclave, as discussed below.

CPM 306 or SPM 312 may initiate a secure provisioning process between client 101 and server 102. For example, CPM 306 may be configured to cause client 101 to initiate provisioning by sending a provisioning request message to server 102. The provisioning request message may be encrypted using server 102's public key if privacy of the request is desired, in which case only server 102 can decrypt the request. In any case, SPM 312 may cause server 102 to analyze the information in the provisioning request message.

Upon analyzing the provisioning request message, SPM 312 may cause server 101 to generate a reply message for transmission to client 101. The reply message may include information that may be used for anti-replay or other purposes, such as a server nonce. The reply message may be signed with a digital signature, and may include information that may be analyzed by client 101 (or, more specifically, by CPM 306) to verify the authenticity of the reply message. In some embodiments, SPM 312 causes server 102 to sign the reply message with a server private key (Sₚᵣᵢᵥ) using a digital signature protocol. In that instance, client 101 may verify the digital signature to the reply message using a corresponding server public key (S_{pub}).

If client 101 can adequately verify the reply message received from server 102, CPM 306 may cause client 101 to protect information in the reply message (e.g., server nonce N) by storing it memory enclave 304. CPM 306 may also cause client 101 to generate its own nonce (M) and securely store it in memory enclave 304.

Further in response to the reply message, CPM 306 may cause client 101 to generate an asymmetric key pair, such as may be used in Rivest, Shamir, Adleman (RSA) public key encryption and/or a digital signature protocol. More specifically, CPM 306 may be configured to cause client 101 to generate an asymmetric key pair including a client public key (C_{pub}) and a client private key (Cₚᵣᵢᵥ), both of which may be stored in and/or sealed to memory enclave 304.

CPM 306 may also cause client 101 to generate an enclave report. The enclave report may include for example a hash of a user data blob (hereinafter, “userdata”) that encapsulates information stored in memory enclave 304. The userdata may encapsulate server nonce N (server anti-replay information), client nonce M (client anti-replay information), and C_{pub}, optionally in combination with other information stored in memory enclave 304. In some embodiments userdata may encapsulate client 101's platform identification (platform ID), a user identification (user ID) of one or more users of client 101, application specific identification information (application specific ID), a security version number (SVN) of memory enclave 304, an identifier of the independent software vendor (ISV) that provisioned memory enclave 304 on client 101, combinations thereof, and the like.

CPM 306 may further cause client 101 to perform enclave quote generation operations. In this regard, CPM 306 may cause client 101 to send an enclave report to a quoting module such as quoting module 307. Without limitation, quoting module 307 is preferably stored and executed within a quoting enclave resident on memory that is local to a processor, such as processor 302. The enclave report sent to quoting module 307 may be signed with a digital signature and/or may include other information which quoting module 307 may use to verify the authenticity of the enclave report For example, CPM 306 may cause client 101 to sign the enclave report using a suitable digital signature protocol and memory enclave 304's enclave key prior to transmitting the enclave report to quoting module 307.

Quoting module 307 may be configured perform enclave report verification operations and enclave quote generation operations consistent with the present disclosure. For example, upon receiving an enclave quote, quoting module 307 may cause client 101 to verify the authenticity of the report. Any suitable verification methodology may be used for this purpose. For example, where the enclave report has been signed with a digital signature, quoting module 307 may cause client 101 to verify the authenticity of the digital signature using an appropriate signature verification protocol. If the signature applied to the enclave report is verified, quoting module 307 may determine that the enclave report was generated by an enclave on client 101 (e.g., memory enclave 304), and not by an unauthorized entity such as malware.

By way of example, CPM 306 may cause client 101 to sign an enclave report with an enclave key (E_{key}), which may be specific to memory enclave 304. In such instances quoting module 307 may cause client 101 to verify the authenticity of the signature to the enclave report using a corresponding key, which may have been pre-provisioned to quoting module 307 or which may be derived from other information. For example, where E_{key} is derived from the client processor ID and/or the hardware profile of the client, quoting module 307 may derive a key that is equivalent to E_{key} from such information and compare signatures made with the equivalent key to the signature applied to the enclave report using E_{key}.

Once quoting module 307 has verified the authenticity of the enclave report it may determine that the enclave report was generated by a valid enclave on client 101 (e.g., enclave 304), and not by an unauthorized entity such as malware. Quoting module 307 may then cause client 101 to generate an enclave quote. The enclave quote may include a copy of the enclave report, optionally in combination with other information. One example of other information that may be included in the enclave quote includes a key or keys that may be used by server 102 to verify digital signatures that may be applied to communications from client 101. For example, quoting module 307 may cause client 101 to generate an enclave quote that includes client 101's public key (i.e., C_{pub}). Further examples of other information that may be included in the enclave quote include the client's platform ID, relevant user IDs, the security version number (SVN) of enclave 304, the identity of the ISV that provided enclave 304, a measurement of enclave 304, application specific identification (ID) combinations thereof, and the like.

After an enclave quote has been generated control may return to CPM 306, which may cause client 101 to send the enclave quote to server 102. For example, CPM 306 may cause client 101 to prepare a quoting message to server 101, which may be optionally encrypted using key such as server's public key. CPM 306 may then cause client 101 to transmit the quoting message to server 102, e.g., via network 315.

In response to the quoting message, SPM 312 may cause server 102 to verify the authenticity of the enclave quote included in an enclave message received from client 101. Verification of the enclave quote may be performed in any manner. For example, SPM 312 may cause server 102 to transfer the quoting message to verification service 313, which may be local or remote to server 102, as illustrated in FIG. 3 by the hashing of box 313. Verification service 313 may verify the enclave quote using a suitable verification protocol. In instances where the enclave quote is signed with a digital signature, verification service 313 may verify the authenticity of the signature using an appropriate digital signature verification protocol. For example, the enclave quote may be signed with a private key of client 101, such as enhanced privacy identification (EPID) private key. In such case, verification service 313 may verify the authenticity of the signature using a corresponding public key, such as an EPID public key.

If the signature applied to the enclave quote is verified, SPM 312 may cause server 102 to verify the integrity of memory enclave 304 by analyzing the enclave quote contained in the quoting message. For example, SPM 312 may cause server 102 to compare a measurement of enclave 304 in the enclave quote against a whitelist of valid enclave measurements stored in a database that is local to or remote from server 102, e.g., optional database 314. Additional information included in the enclave quote (if any) may be verified in a similar manner, e.g., by comparing the additional information to a corresponding white list of information stored in optional database 314.

If all of the verification operations successfully complete, SPM 312 may determine that memory enclave 304 on client 101 is valid and trusted. SPM 312 may then cause server 102 to generate a whitelist identity (whitelist ID) for client 101, and to store all or a portion of the content of the enclave quote in a whitelist database in association with the whitelist ID. SPM 312 may also cause server 102 to send a message including the whitelist ID to client 101. In response to such message, CPM 306 may cause client 101 to store the whitelist ID to memory enclave 304. In particular, CPM 306 may cause client 101 to seal the whitelist ID and other client authentication credentials (e.g., client key(s), user identification, machine identification, application specific ID, etc. to memory enclave 304, e.g. by encrypting such information with memory enclave 304's enclave key (E_{key}).

The technology described herein may thus be used to provision client 101 with a whitelist ID. The whitelist ID and other secrets of client 101 (e.g., its platform ID, user ID, SVN, ISV, enclave key (E_{key}), enclave measurement etc.) may be stored in and/or sealed to enclave 304 while not in use, and thus may be protected from attack by malware resident on client 101. The provisioning technology also results in the provisioning of server 102 with a client whitelist ID and other secrets (e.g. the contents of an enclave quote), which may be stored in memory that is local to or remote from server 102, such as database 314.

After provisioning, client 101 may authenticate itself to server 102 by unsealing the secrets within secure enclave 304 and sending its whitelist ID to server 102, e.g., in a signed message. Server 102 can verify the authenticity of the client by verifying the signature applied to the message and comparing the whitelist ID of the client to whitelist IDs of approved platforms. Because client 101 may unseal the secrets within memory enclave 304, the plaintext of such secrets may be protected from malware or other unauthorized entities resident on client 101. The technologies of the present disclosure may therefore protect client authentication credentials and other information as it is provisioned to a client, stored on a client, used on a client, and combinations thereof.

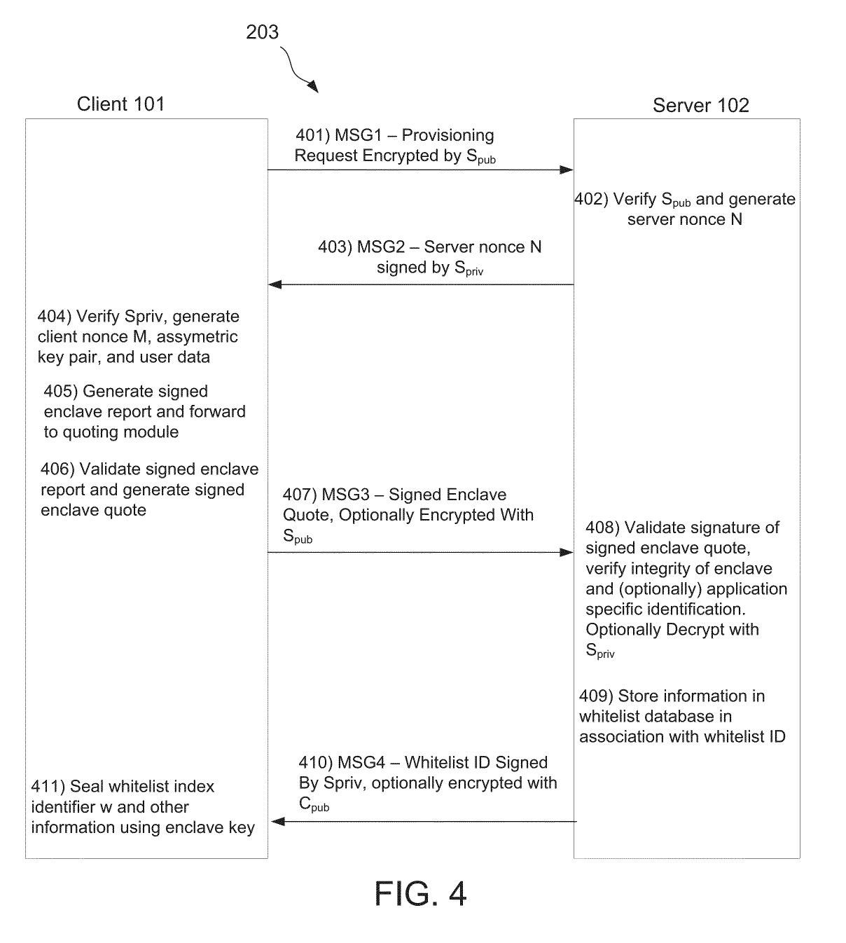

FIG. 4 illustrates a messaging flow of an exemplary provisioning method consistent with the present disclosure. The messaging flow of FIG. 4 is generally labeled with numeral 203, as it illustrates exemplary operations that may be performed by a client and server in accordance with provisioning block 203 of FIG. 2. For the sake of this discussion, it is assumed that client 101 and server 102 are configured as shown in FIG. 3, and that they each have a source of entropy for generating notices, such as a random number generator. It is also assumed that a signing key pair has been generated for server 102 prior to execution of the messaging flow, with the client possessing a server public key (S_{pub}) and the server possessing a server private key (Sₚᵣᵢᵥ). S_{pub} may be stored within and/or sealed to memory enclave 304 and thus may be protected from malware that may be resident on client 101. Indeed, tampering with S_{pub} within memory enclave 304 may produce a detectable change in the measurement of memory enclave 304, which may be considered evidence of tampering.

In this exemplary messaging flow, a user of client 101 may wish to receive digital information (e.g., software, documents, etc.) from server 102. Prior to this point however, server 102 may not trust client 101. Client 101 and server 102 may therefore execute a provisioning method to establish a root of trust and to facilitate provision initial secrets on client 101.

To begin, client 101 or server 102 may initiate provisioning. This concept is illustrated in FIG. 4, which depicts client 101 as initiating provisioning. In this case, computer readable instructions of CPM 306 when executed may pursuant to element 401 cause client 101 to send a provisioning request (MSG1) to server 102. For security or another purpose, the provisioning request may be encrypted by client 101, e.g., using a single key encryption, symmetric key encryption, asymmetric key encryption, or the like. In some embodiments, the provisioning request is protected via an asymmetric key encryption protocol. This concept is illustrated in FIG. 4, wherein client 101 encrypts MSG1 with server 102's public key, S_{pub}.

The method may then proceed to element 402, wherein server provisioning module (SPM) instructions of SPM 312 when executed may cause server 102 to verify the authenticity of provisioning requests it receives using any suitable verification protocol. For example, server 102 may verify a received provisioning request by attempting to decrypt the provisioning request, e,g., with its private key (i.e., Sₚᵣᵢᵥ). If it is able to successfully decrypt the provisioning request with Sₚᵣᵢᵥ, server 102 may be confident that the request originated from a client having knowledge of S_{pub}. At this point, the SPM instructions when executed may cause server 102 to generate a server nonce (N) (server anti-replay information) using a local or remote source of entropy such as a random number generator.

The method may then proceed to element 403, wherein the SPM instructions when executed may cause server 102 to generate a provisioning response message (MSG2) including server nonce N. The SPM instructions may also cause server 102 to sign MSG2 with a signing key that may be verified by client 101, e.g. the server's private key (Sₚᵣᵢᵥ). Once MSG2 is signed, the SPM instructions may cause server 102 to transmit the signed MSG2 to client 101. At this point, the method may proceed to elements 404-406.

Pursuant to element 404 CPM instructions of CPM 306 when executed may cause client 101 to verify the signature applied to MSG2. In instances where server 102 signed MSG2 with Sₚᵣᵢᵥ, for example, the CPM instructions may cause client 101 to verily the authenticity of the signature using S_{pub}. If the verification succeeds the CPM instructions may cause client 101 to store server nonce N in memory enclave 304. The CPM instructions may also cause client 101 to generate a client nonce M (client anti-replay information) using a local or remote source of entropy. Like server nonce N, the CPM instructions may cause client 101 to store client nonce M within memory enclave 304.

The CPM instructions when executed may further cause client 101 to generate an asymmetric key pair, such as may be used in Rivest, Shamir, Adleman (RSA) public key encryption. More specifically, the CPM instructions may cause client 101 to generate an asymmetric key pair including a client public key (C_{pub}) and a corresponding client private key (Cₚᵣᵢᵥ), both of which may be stored in memory enclave 304.

The method may then proceed to element 405, wherein the CPM instructions when executed may cause client 101 to calculate a user data blob (userdata). The userdata may encapsulate server nonce N, client nonce M, C_{pub}, and optionally other information as discussed previously. The CPM instructions may further cause client 101 to generate an enclave report. Without limitation, the enclave report may include a hash of the userdata, either alone or in combination with other information as previously described.

The CPM instructions may then cause client 101 to sign the enclave report (including a hash of user data and optional identification information), with a signing key. In some embodiments the CPM instructions may cause client 101 to sign the enclave report using an enclave key (E_{key}), which may have been pre-provisioned within memory enclave 304, e,g., at the time memory enclave 304 was established on client 101. E_{key} may be specific to the hardware of client 101. That is, E_{key} may correspond to or be derived from the processor ID of processor 302, a hardware profile of client 101, combinations thereof, and the like. Alternatively or additionally, E_{key} may be specific to the owner of memory enclave 304, e.g., the independent software vendor (ISV) that established memory enclave 304 on client 101, in which case E_{key} may be understood to be an ISV signing key.

Once a signed enclave report has been generated the method may proceed to block 406, wherein the CPM instructions may cause client 101 to validate the signed enclave and generate a signed enclave quote. In this regard the CPM instructions may cause client 101 to forward the signed enclave report to a quoting module, such as quoting module 307 of FIG. 3, which may be an independent secure enclave executed close to the processor of client 101 and may include computer readable quoting module instructions. In response to receiving the signed enclave report, the quoting module instructions may cause client 101 to verify the signature applied to the signed enclave report. For example the quoting module instructions may cause processor 302 to verify the signature applied to the signed enclave report against a signature obtained from a client platform key (P_{key}) key. P_{key} may be equivalent to E_{key}, and may be stored within the quoting module. If the signatures are identical, the quoting module may determine that a valid secure enclave on the client generated the signed enclave report.

Once the signed enclave report is validated, the quoting module instructions may cause client 101 to generate a secure enclave quote that may include various information as discussed above. The quoting module instructions may further cause client 101 to sign the enclave quote using a signing key such as the client's EPID private key, which may have been pre-provisioned on the client. The method may then proceed to block 407, wherein the CSM instructions when executed cause client 101 to send a message (MSG3) encapsulating the signed enclave quote to server 102. As shown in FIG. 4, MSG3 may be optionally encrypted, e.g., using the server public key, S_{pub} or another key.

The method may then proceed to element 408, wherein SPM instructions when executed may cause server 102 to perform various operations on MSG3. For example if client 101 encrypted MSG3 with public key encryption and a server public key (e.g., S_{pub}), the SPM instructions may cause server 102 to decrypt MSG3 using a decryption protocol and a corresponding server private key (e.g., Sₚᵣᵢᵥ). Once MSG3 is decrypted (or if MSG3 was not encrypted), the SPM instructions when executed may cause server 102 to verify the digital (e.g., EPID) signature applied to the signed secure enclave quote, using a verification service that is local to or remote from server 102. In any case, the verification service may have knowledge of one or more keys that correspond to the key used by client 101 to sign the enclave quote. For example, where the enclave quote was signed with client 101's EPID private key, the verification service may verify the authenticity of the EPID private key using a corresponding EPID public key in accordance with known EPID verification protocols.

The SPM instructions when executed may also cause server 102 to verify the integrity of memory enclave 304 on client 101. For example, the SPM instructions may cause server 102 to compare the enclave measurement included in the secure enclave quote against a whitelist of valid enclave measurements, which may be stored in a local or remote database such as database 314 of FIG. 3. If other identifying indicia (e.g., the client's machine identifier, user ID's of authorized users of client 101, application specific identification information, an independent software vendor (ISV) identifier, a security version number (SVN) of memory enclave 304, etc.) is included in the secure enclave quote, the CPM instructions may cause server 102 to verify such information as well, e.g., by comparing such information to a whitelist of identification indicia stored in database 314 or at another location.

In some instances the signed enclave quote may include a hash of userdata and server nonce M. In those cases the SPM instructions when executed may cause server 102 to verify the userdata hash against a white list of approved userdata hashes. Moreover, the SPM instructions when executed may cause server 102 to verify server nonce M, e.g., for anti-replay purposes.

The method may then proceed to element 409, wherein SPM instructions when executed may cause server 102 to store all or a portion of the information in the enclave quote/report within a local or remote memory, e.g., in optional database 314. For example, the SPM instructions may cause server 102 to store the measurement of enclave 304, client username (if included), client machine ID (if included), application specific information (if included), the hash of userdata, and the client public key (C_{pub}) in optional database 314 or another data structure. The SPM instructions may also cause server 102 to generate a whitelist ID for client 101, which may be stored in association with information received in the enclave quote. For example, the SPM instructions may cause server 102 to store the whitelist ID in database 314, in association with other information received from client 101.

The method may then proceed to clement 410, wherein the SPM instructions may cause server 102 to send the whitelist ID to client 101. In this regard, the SPM instructions may cause server 102 to prepare a message (MSG4) including the whitelist ID, which may be optionally signed with Sₚᵣᵢᵥ and/or encrypted using C_{pub}. In any case, the SPM instructions may cause server 102 to transmit MSG4 to client 101 via wired or wireless communication, e.g., using network 315.

The method may then proceed to element 411, wherein the CPM instructions when executed may cause client 101 to verify the authenticity of MSG4. For example, where MSG4 is signed with server 102's private key (e.g., Sₚᵣᵢᵥ), the CPM instructions when executed may cause client 101 to verify the authenticity of the signature using a corresponding public key (e.g., S_{pub}). Alternatively or additionally, if MSG4 is encrypted with C_{pub}, the CPM instructions when executed may cause client 101 to decrypt MSG4 within memory enclave 304 using a corresponding private key (e.g., Cₚᵣᵢᵥ). In this way, the whitelist ID may be obtained by client 101 within memory enclave 304 and thus protected from malware. The CPM instructions may also cause client 101 to seal the whitelist ID to memory enclave 304, e.g., by encrypting the whitelist ID with memory enclave 304's enclave key.

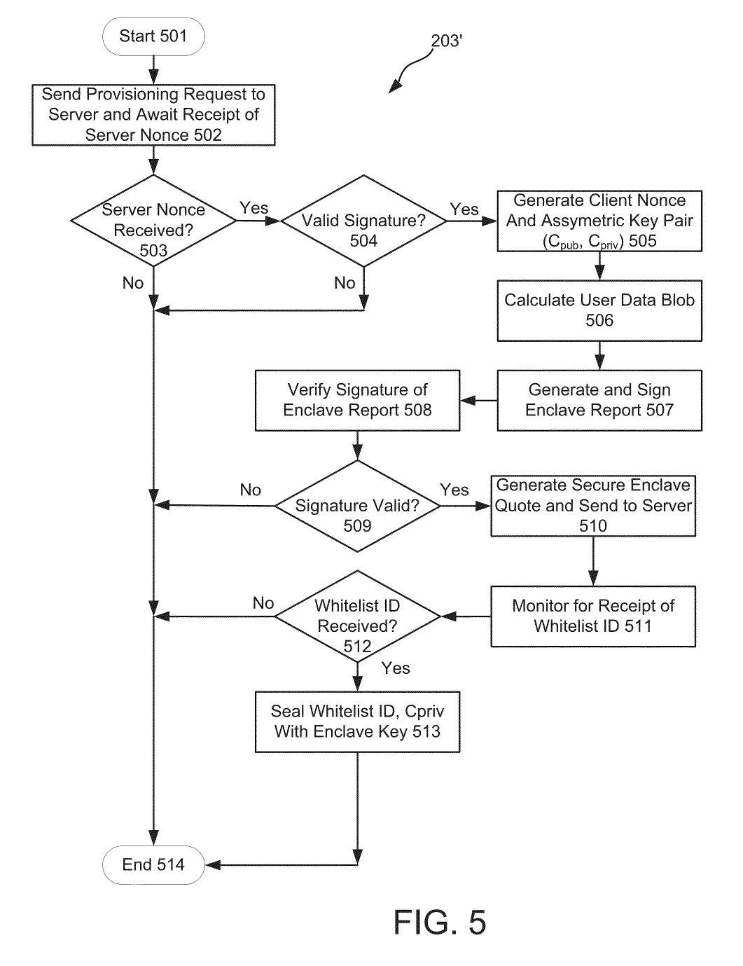

Reference is now made to FIG. 5, which depicts a flow diagram of exemplary client operations that may be performed in accordance with a client provisioning method consistent with the present disclosure. The method of FIG. 5 is generally labeled with numeral 203′, as it illustrates exemplary client operations that may be performed in accordance with provisioning block 203 of FIG. 2. As shown, the method begins at block 501. At block 502, the client may send a provisioning request to a server and await receipt of a server nonce (server anti replay information), as generally described above. At block 503, a determination may be made as to whether a server nonce has been received. If not, the method may proceed to block 514 and end. Otherwise the method may proceed to block 504.

At block 504 a determination may be made as to whether a digital signature applied to the message including the server nonce is valid, as discussed above. If the signature is not valid, the method may proceed to block 514 any end. Otherwise the method may proceed to block 505, wherein the client may generate a client nonce (N) (client anti-replay information) and an asymmetric key pair (C_{pub}, Cₚᵣᵢᵥ).

The method may then proceed to block 506, wherein the client may calculate a user data blob, as described previously. Once the user data blob has been calculated, the client may pursuant to block 507 generate and sign an enclave report including the user data blob and other information.

At block 508, a quoting module on the client may verify the digital signature applied to the enclave report. At block 509, a determination may be made as to whether the signature applied to the enclave report is valid. If not, the method may proceed to block 514 and end. If the signature is valid however, the method may proceed to block 510 wherein the quoting module may generate a secure enclave quote and transmit the quote to a server. As noted previously, the enclave quote may be optionally encrypted prior to transmission.

The method may then proceed to block 511, wherein the client may monitor for the receipt of a whitelist ID. The client may receive the whitelist ID in a communication from the server or another entity. The method may proceed to block 512, wherein a determination may be made as to whether a whitelist ID was received. This determination may be conditioned on the expiration of a predetermined time period for receiving the whitelist ID. If a whitelist ID has not been received (or was not received within the predetermined time period), the method may proceed to block 514 and end. If a whitelist ID was received however, the method may proceed to block 513 wherein the client may seal the whitelist ID and other authentication information (e.g., Cₚᵣᵢᵥ, client ID, etc.) to its secure enclave. The method may then proceed to block 514 and end.

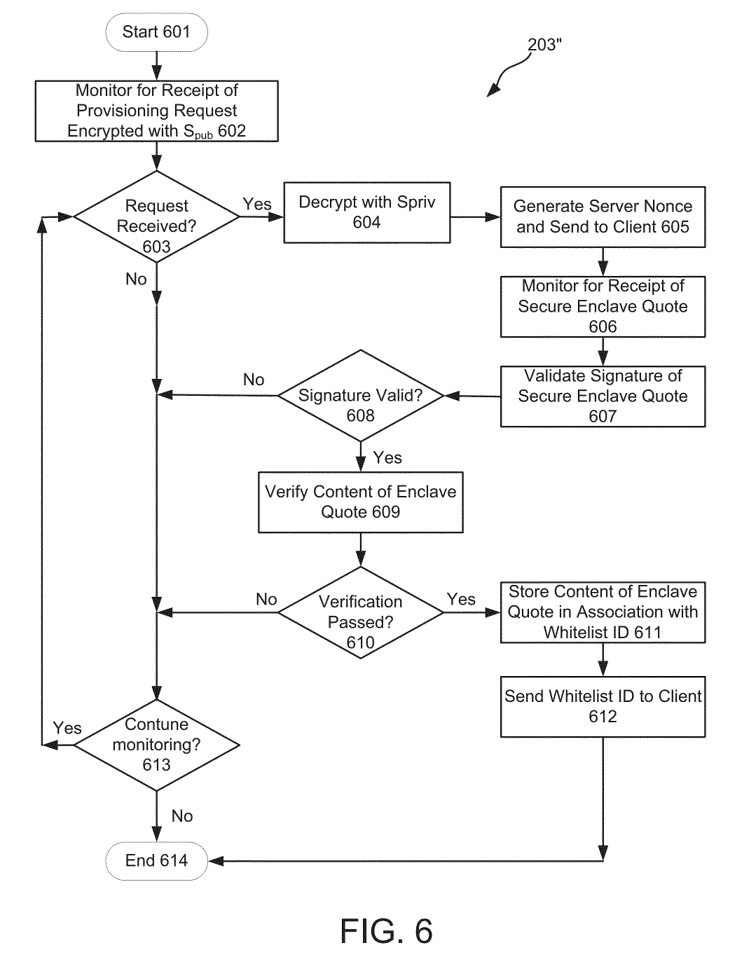

FIG. 6 depicts a flow diagram of exemplary server operations that may be performed by a server in accordance with provisioning block 203 of FIG. 2, and thus is generally labeled with numeral 203″. As shown, the method begins at block 601. At block 602, the server may monitor for receipt of a provisioning request from a client, which may have been encrypted by the client with a server public key (S_{pub}) as described above. At block 603, a determination may be made as to whether a provisioning request has been received, e.g., within a predetermined time period. If not, the method may proceed to block 613, wherein a determination may be made as to whether monitoring is to continue. If so, the method may loop back to block 603. If not, the method may proceed to block 614 and end. If a provisioning request has been received, the method may proceed to block 604, wherein the server may decrypt the provisioning request, e.g., using its private key (Sₚᵣᵢᵥ).

The method may then proceed to block 605, wherein the server may generate a server nonce (N). In addition, the server may transmit the server nonce (N) in a message to the client. Pursuant to block 606, the server may monitor for the receipt of a secure enclave quote, which may be generated and transmitted to the server as discussed above. Once a server quote has been received, the method may proceed to block 607, wherein the server may validate the enclave quote. For example, when the enclave quote has been signed with a digital signature, the server (or a remote verification service) may verify the authenticity of the digital signature using an appropriate signature verification protocol.

At block 608 a determination may be made as to whether the enclave quote (or, more specifically, the signature applied thereto) is valid. If not, the method may proceed to block 613, wherein a determination may be made as to whether monitoring is to continue. If so, the method may loop back to block 603. If not, the method may proceed to block 614 and end. If the enclave quote (and/or its signature) is valid, the method may proceed to block 609, wherein the server may verify the content of the enclave quote, as discussed above. For example, where the enclave quote includes a measurement of a secure enclave on a client, the server may verify the measurement against a whitelist of enclave measurements which may he stored in a database that is local to or remote from the server.

At block 610, a determination may be made as to whether the content of the enclave quote is verified. If not, the method may proceed to block 613, wherein a determination may be made as to whether monitoring is to continue. If so, the method may loop back to block 603. If not, the method may proceed to block 614 and end. If the content of the enclave quote is verified the method may proceed to block 611, wherein the server may store the content of the enclave quote, e.g., in a local or remote database. The server may also generate a whitelist ID, which may also be stored in connection with the content of the enclave quote. The method may then proceed to block 612, wherein the server may send the whitelist ID to the client, e.g., in a signed and optionally encrypted message. At block 614, the method ends.

As may be appreciated from the foregoing, the technology of the present disclosure may securely provision initial secrets on client 101, server 102, or a combination thereof. Specifically, client 101 may be provisioned with a client private key (Cₚᵣᵢᵥ), other authentication information (e.g., a user ID, application specific ID, combinations thereof, and the like), a whitelist ID, and a server public (S_{pub}), any or all of which may be securely stored within or sealed to client 101's memory enclave. Likewise, server 102 may be provisioned with the client's whitelist ID and information in the client's enclave quote, which it may store in a local or remote database.

As will be described later the secrets provisioned on client 101 and server 102 may be later used to facilitate the establishment of a secure communications channel. That channel may be used to securely transfer information between such devices. While this has particular use in the ERM context (e.g., to facilitate secure transfer of licenses to encrypted digital information on client 101), it should be understood the secure communications channel (and other technology described herein) is not limited to that context. Indeed, the secrets provisioned on client 101 may be used to authenticate client 101 to server 102 and to establish a secure communications channel that may be used securely transfer any type of information from server 102 to client 101, and vice versa.

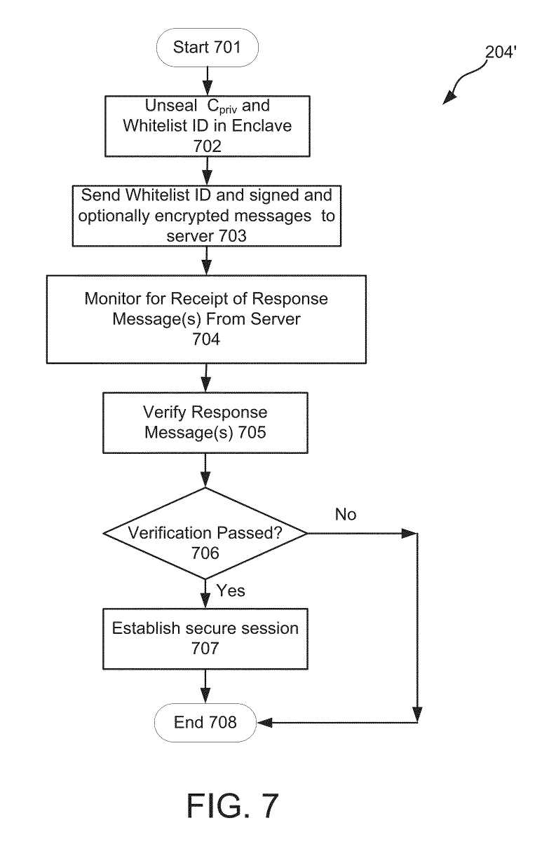

FIG. 7 is a flow diagram of exemplary client operations that may be performed in connection with the establishment of a secure communications channel (session) between a client and server consistent with the present disclosure. The method of FIG. 7 is generally labeled with numeral 204′, as it illustrates exemplary operations that may be performed by a client in accordance with secure session establishment block 204 of FIG. 2. For the sake of discussion, it is assumed that a client and server are configured as shown in FIG. 3. It is further assumed that the client and server have been provisioned with secrets as discussed above, and that secrets provisioned to the client are sealed to the client's memory enclave (e.g., memory enclave 304). Although not expressly discussed, it should also be understood that operations performed in connection with FIG. 7 may be caused by the execution of a secure session establishment module (SSEM) on a client device, which may be independent from or included in a client provisioning module (CPM) or a client enterprise rights enforcement module (CEREM) that may be resident on client 101.

As shown, the method begins at block 701. At block 702, client 101 may unseal client private key (Cₚᵣᵢᵥ), its white list ID, and optionally server public key (S_{pub}) from its memory enclave using its enclave key (E_{key}). Without limitation, client 101 preferably unseals these items within its memory enclave, such that their plaintext is protected from malware.

Once Cₚᵣᵢᵥ, the white list ID and optionally S_{pub} are unsealed, the method may proceed to block 703, wherein client 101 may generate one or more authentication request messages. The authentication request message(s) may encapsulate the whitelist ID and optionally other information that may be used to authenticate client 101. For example, the information request message may include a measurement of client 101's memory enclave, the SVN of the client's memory enclave, etc. In any case, client 101 may sign the authentication request message using Cₚᵣᵢᵥ, and may optionally encrypt the request message using S_{pub}. In some embodiments, the client's whitelist ID may be included as plaintext in the authentication request message, whereas other portions of the message may be signed and optionally encrypted as previously described. In any case, client 101 may then send the signed, optionally encrypted authentication request message to server 102.

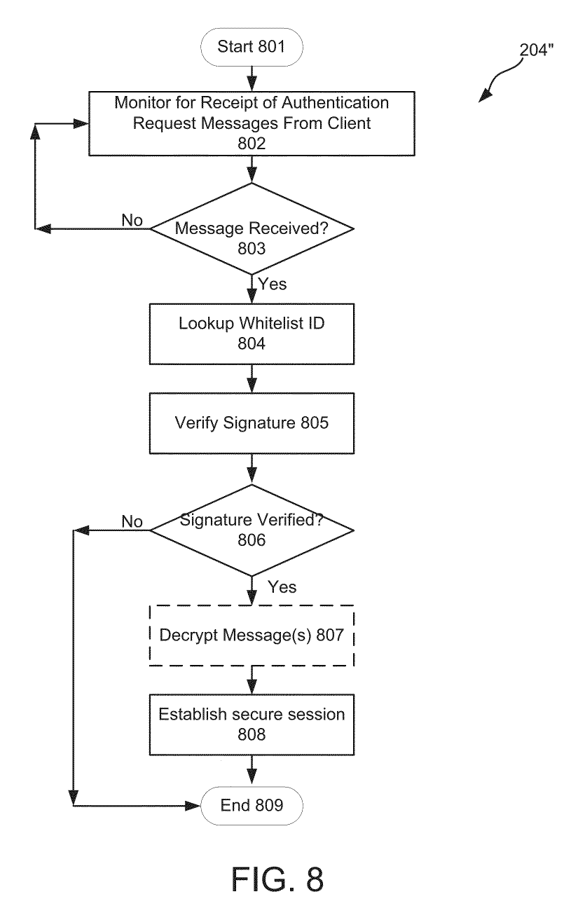

As will be described later in connection with FIG. 8, server 102 may perform authentication and validation operations on authentication request messages received from client 101. Once server 102 successfully verifies the authenticity of the authentication request messages, it may examine the content of such messages to determine if the content therein is valid. If the content is valid, server 102 may generate and send a response message to client 101, which may be optionally encrypted with the client's public key (C_{pub}) and optionally signed using the server's private key (Sₚᵣᵢᵥ).

Returning to FIG. 7, client 101 pursuant to block 704 may monitor for the receipt of response messages from server 102. Although not shown in FIG. 7, if a response message from server 102 is not received (or is not received within a pre-allocated time limit), the method array proceed to block 708 and end. If a response message is received the method may proceed to block 705, wherein client 101 may perform verification operations on the received response message. For example, client 101 may attempt to decrypt the response message using Cₚᵣᵢᵥ if the response message was encrypted by server 102 using C_{pub}. If such decryption is successful, client 101 may be confident that the response message originated from a party with knowledge of C_{pub}, i.e., server 102.

To further verify the authenticity of the response message(s), client 101 may validate the digital signature applied to such messages by server 102. For example if server 102 signed a response message using its private key (e.g., Sₚᵣᵢᵥ), client 101 may verify the signature using a corresponding public key (e.g., S_{pub}) using known signature verification protocols. For this purpose, client 101 may at this time unseal S_{pub} within its enclave, if S_{pub} was not previously unsealed.

The method may then proceed to block 706, wherein a determination may be made as to whether the response message was successfully validated. If validation of the response message is unsuccessful, the method may proceed to block 708 and end. If validation of the response message was successful the method may proceed to block 707, wherein client 101 may establish a secure session (communications channel) with server 102. In some embodiments, client 101 and server 102 may establish a secure session in which they encrypt messages to one another using their respective public keys. That is, server 102 may encrypt messages to client 101 using C_{pub}, and client 101 may encrypt messages to server 102 using S_{pub}. Client 101 and server 102 may decrypt those encrypted messages using their corresponding private keys, i.e., Cₚᵣᵢᵥ, and Sₚᵣᵢᵥ. In this way, client 101 and server 102 may securely communicate and exchange information using their corresponding public and private keys.

Alternative or additionally, client 101 and server 102 may negotiate a secure session based on the use of a shared session key (SSK). By way of example, upon their mutual authentication client 101 and server 102 may execute a sign and message authentication code (SIGMA) protocol or another suitable protocol for establishing an SSK. In any case, the SSK may be ephemeral or permanent. If ephemeral the SSK may remain valid for a set number (e.g., 1, 2, etc.) of sessions or for a set time period, after which a new SSK may be needed. In any case client 101 and server 102 may use the SSK to encrypt messages to one another while the secure session is active. Because they each have knowledge of the SSK, client 101 may decrypt messages encrypted with the SSK from server 102, and vice versa. In this way, client 101 and server 102 may securely exchange messages using the shared session key. After the secure session has been established, the method may proceed to block 708 and end.

Although the use of a SIGMA protocol to generate and use an SSK is one suitable mechanism for establishing secure session, other mechanisms may also be used and are envisioned by the present disclosure. Indeed, any suitable cryptographic protocol may be used for establishing a secure communications session between a client and a server consistent with the present disclosure.

Once a secure session has been established, client 101 may send information request messages to server 102. Such messages may be optionally signed and optionally encrypted using an SSK or the server's public key, S_{pub}. Server 102 may optionally verify and decrypt such messages, and transmit the requested information to client 101. This capability may be of particular use in the enterprise rights management context. Indeed, client 101 may use the secure session to securely transmit requests for digital information, licenses to digital information, etc. to server 102, and server 102 can use the secure session to provide the requested content in response messages encrypted in accordance with the secure session. Likewise, server 102 may use the secure channel to securely distribute modules, software, etc., to client 101.

Reference is now made to FIG. 8, which is a flow diagram of server operations that may be performed in connection with an exemplary secure information transfer method consistent with the present disclosure. This method is generally labeled with numeral 204″, as it illustrates exemplary operations that may be performed by a server in accordance with secure session establishment block 204 of FIG. 2. Although not expressly described, it should be understood that operations performed pursuant to FIG. 8 may be caused by the execution of one or more modules on a server, such as SPM 312 or a server enterprise rights management module (SERMM).

As shown, the method begins at block 801. At block 802, the server may monitor for receipt of an authentication request message from client 101. The method may then proceed to block 803, wherein a determination may be made as to whether an information request message has been received. If not, the method may loop back to block 802 and repeat. If an authentication request message has been received however, the method may continue to block 804.

As noted previously an authentication request message may include a client's whitelist ID, as well as a digital signature. Pursuant to block 804, the server may verify the whitelist ID in the information request message against a database of pre-approved whitelist ID's, which may be stored locally or remotely from server 102, e.g., in database 314 of FIG. 3.

If the whitelist ID in the information request message matches a pre-approved whitelist ID, the method may proceed to block 805, wherein server 102 may validate the digital signature applied to the authentication request message. For example, in instances where an authentication request message is signed with client 101's private key (E.g., Cₚᵣᵢᵥ, an EPID private key, etc.), server 102 may validate the signature using a corresponding public key (e.g., Cₚᵣᵢᵥ, an EPID public key, etc.), which may have been stored in association with the pre-approved whitelist ID, e.g., in database 314 of server 102.

The method may then proceed to block 806, wherein a determination may be made as to whether the signature was successfully verified. If not, the method may proceed to block 809 and end. If the signature is successfully verified, the method may proceed to optional block 807, wherein server 102 may decrypt the information request message, if necessary. It is again noted that client 101 may encrypt all or a portion of the information request message using the server's public key, S_{pub}, in which case server 101 may decrypt such messages using its private key, Sₚᵣᵢᵥ.

Once decryption is complete (or if the information request message was not encrypted) the method may proceed to block 808. Pursuant to this block server 102 may negotiate a secure communications session with client 101, e.g., using a negotiated SSK and/or client 101 and server 102's public and private keys, as previously described. Without limitation, server 102 and client 101 preferably negotiate an ephemeral SSK, which may then be used to encrypt all messages between client 101 and server 102 while the secure communication session is active. The method may then proceed to block 809 and end.

Once a secure communication session has been established, server 102 may monitor for the receipt of information request messages from client 101. Upon receipt, server 102 may decrypt such messages with an appropriate key (e.g., an SSK or Sₚᵣᵢᵥ), analyze the content of the information request, and transmit the requested information to client 101 the secure channel. For example, where an information request message requests a license to encrypted digital information, server 102 may send such license to client 101 in one or more messages encrypted with an SSK and/or the client's public key (C_{pub}), as appropriate.

As discussed above, the technology of the present disclosure may permit secure provisioning secrets on client platforms, as well as the establishment of a client whitelist ID on the client and a server. These elements may be used to rapidly authenticate the client to a server, e.g., during a light weight protocol to establish a secure communication channel between the client and server for the exchange of information. As will be discussed below, this capability and other features of client 101 may be leveraged to harden the security of assets that may be used in the enforcement of an information security protocol, such as the one described above in connection with FIGS. 1A and 1B. In particular, the technology described herein be useful to harden the security of assets that may be used in an enterprise rights management (ERM) protocol.

Client 101 may receive encrypted digital information from a source in any suitable manner, as previously discussed. Upon receipt, client 101 may store the encrypted digital information in an appropriate manner. For example, if the received digital information is to be kept private or otherwise secured, client 101 may seal or store such information to/within its memory enclave, e.g., memory enclave 304 of FIG. 3, protecting it from malware and other software that may be resident on client 101.

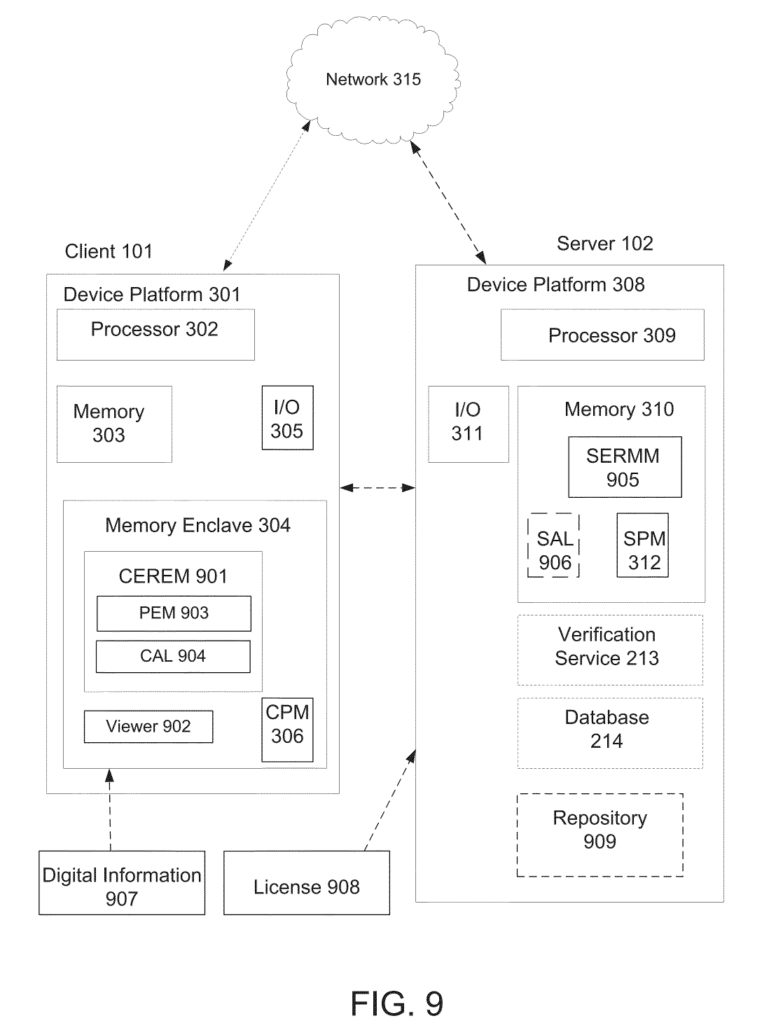

Another aspect of the present disclosure relates to systems for managing enterprise rights over digital information provided to a client device. Reference is therefore made to FIG. 9, which depicts exemplary system architecture of an ERM system consistent with the present disclosure. As shown the ERM system includes client 101 and server 102, which may communicate directly or indirectly using network 315. The nature and function of network 315 and many of the components of client 101 and server 102 in FIG. 9 are the same as those previously described in connection with FIG. 3, and for the sake of brevity will not be repeated.

As shown, client 101 may store client enterprise rights enforcement module (CEREM) 901 in secure enclave 304. This module may generally function to perform enterprise rights management operations consistent with the present disclosure. Client 101 may also include policy enforcement module (PEM) 903 and client activity log (CAL) 904. Those components may be included in or separate from CEREM 901, and may function to perform policy information and activity logging operations, respectively, as will be discussed below. Client 101 may further include viewer module 902, which may function to facilitate viewing and other interaction with digital information on client 101. Without limitation, any or all of CEREM 901, PEM 903, CAL 904, and viewer module 902 may have been provided to client 101 from server 102 or another source, e.g., using a secure provisioning process consistent with the present disclosure. As also shown, server 102 may include server enterprise rights management module (SERMM) 905, a server activity log (SAL) 906, and optional information repository 909.

In operation, client 101 may receive encrypted digital information, and server 102 may receive a license to the encrypted digital information. This concept is illustrated in FIG. 9, wherein client 101 is provided with digital information 907, and server 102 is provided with license 908. Without limitation, digital information 907 and license 102 may be provided from one or more sources, such as but not limited to a distributor (e.g., distributor 103 of FIG. 1B). Alternatively or additionally, digital information 907 and license 908 may be stored within optional repository 909 or in another memory of server 102. In such instances, client 101 may receive digital information 907 from server 102. In any case, FIG. 9 may be understood as illustrating exemplary ERM system architecture for the security model discussed above in connection with FIG. 1B.

Consistent with the security model of FIG. 1B, digital information 907 may be encrypted with first encryption protocol using one or more information encryption keys hereinafter referred to as I_{key}. License 908 may therefore include one or more keys for decrypting the encrypted digital information, optionally in combination with one or more information access policies governing access to the encrypted digital information. The cipher text of digital information 907 may be stored in within a memory of client 101, and may optionally be sealed by client 101 to memory enclave 304, e.g. using secure enclave 304's enclave key (E_{key}). Digital information 907 may thus be protected by encryption as it is provided to client 101 and stored on client 101.

In this embodiment, server 102 is assumed to be secure and thus license 908 may be stored within unsecured memory of server 102. Alternatively, server 102 may include a server-side secure enclave, in which case license 908 may be sealed to the server-side secure enclave, e.g., using the server-side secure enclave's key or another key.

Although not shown in FIG. 9, client 101 may further include an interface module, which may function to provide an interface through which a user of client 101 may select digital information for interaction. The interface module may be stored in memory 303, within secure enclave 304, or in another memory. Regardless, the interface module may include interface instructions that when executed cause client 101 to produce an interface (e.g., a graphical user interface on a display thereof. The interface may be configured to enable a user to identify digital information present on client 101, and to select digital information for viewing, modification, or other interaction.

By way of example, a user may utilize a user interface component to select digital information for display. In response to such selection, instructions within CEREM 901 may attempt to decrypt the cipher text of digital information 907. If decryption is successful the plaintext of the digital information may be forwarded to viewer module 902, which may process the plaintext for display on media hardware of client 101. Viewer module 902 may thus be configured to process digital information of the type corresponding to digital information 907 for display. For example, where digital information 907 is an electronic document, viewer module 902 may be capable of processing such documents. Similarly, if digital information 907 is audio and/or video information, viewer module 902 may be capable of processing such audio and/or visual information for display.

Initially, CEREM 901 may be unable to decrypt digital information 907 because client 101 may not possess or have access to an appropriate decryption key. For example, digital information 907 may be encrypted with a single key encryption protocol using I_{key}, in which case client 101 may be unable to decrypt the cipher text of digital information 907 without I_{key}. Similarly, digital information 907 may be encrypted using a public key encryption protocol, wherein I_{key} may correspond to a public key. In such instances, client 101 may be unable to decrypt the cipher text of digital information 907 without knowledge of a private key corresponding to I_{key}.

CEREM 901 may be configured to cause client 101 to attempt to obtain a copy of a license including a key for decrypting the plaintext of digital information 907. More specifically CEREM 901 may include instructions that when executed cause client 101 to query one or more sources for a license to digital information 907. Non-limiting examples of such sources include a distributor (not shown) of digital information 907 (e.g., server 102 or another device), another device, combinations thereof, and the like. In the non-limiting embodiment of FIG. 9, server 102 has been provided with a copy of license 908, which governs access to digital information 907. CEREM 901 may therefore be configured to cause client 101 to request a copy of license 908 from server 102, e.g., via a secure communication established between the devices as discussed previously.

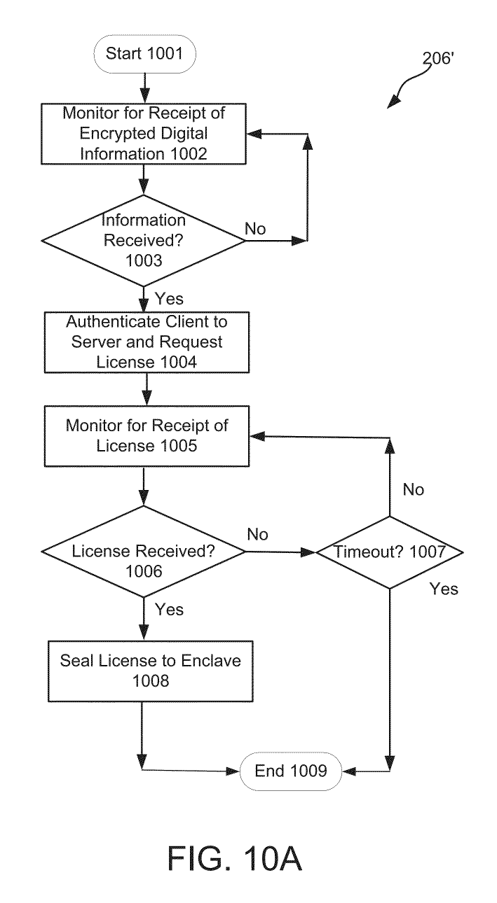

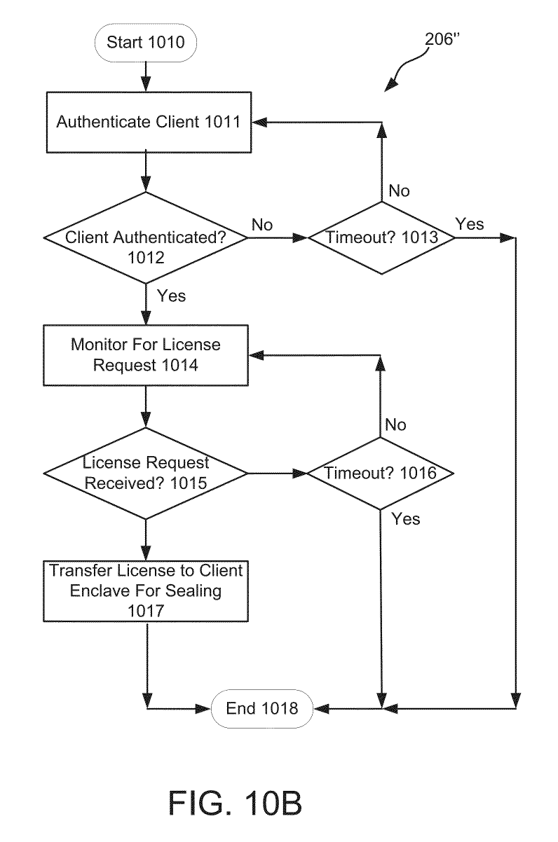

Another aspect of the present disclosure relates to methods for securely requesting and distributing licenses governing access to encrypted digital information on a client. Reference is therefore made to FIG. 10A, which depicts a flow diagram of client operations that may be performed in connection with an exemplary secure license distribution method consistent with the present disclosure. This method is generally labeled with numeral 206′, as it illustrates exemplary operations that may be performed by a client in accordance with secure distribution block 206 of FIG. 2. For the sake of discussion it is assumed that the method will be implemented using a client that includes the components of client 101 as illustrated in FIG. 9. It is further assumed that client 101 and server 102 have executed a secure provisioning method (as described above) such that client 101 is provisioned with secrets that may be used to establish a secure communications channel/session with server 102.

As shown the method begins at block 1001. At block 1002, computer readable instructions within a CEREM (e.g., CEREM 901) when executed may cause the client to monitor for receipt of encrypted digital information from a source. The method may proceed to block 1003, wherein a determination may be made as to whether encrypted digital information has been received. If not, the method may loop back to block 1002 and repeat. If encrypted digital information has been received, the CEREM may cause the client to seal the information to a memory enclave, such as memory enclave 304.

The method may then proceed to block 1004, wherein CEREM instructions may cause the client to authenticate itself to a server. Authentication of the client to the server may be performed using secrets provisioned to the client, as discussed above. Once authentication of the client is complete, the CEREM instructions may cause the client to send a license request message to the server over a secure communications channel. Without limitation, the license request message may be encrypted using a shared session key, the server's public key, or another key, as generally discussed above. Among other things, the license request may include a request for a license that includes one or more keys that may be needed to decrypt the encrypted digital information.

The method may then proceed to block 1005, wherein the CEREM instructions when executed may cause the client to monitor for the receipt of a license from the server. If a license has not been received, the method may proceed to block 1007, wherein a determination is made as to whether a pre-determined time period has elapsed. If so, the method may proceed to block 1009 and end. If the time period has not elapsed, the method may loop back to block 1005. Once a license is received, the method may proceed to block 1008, wherein the CEREM may cause the client to seal the received license to its memory enclave, using an enclave key. The method may then proceed to block 1009 and end.

Reference now made to 10B, which depicts a flow diagram of server operations that may be performed in connection with an exemplary secure license distribution method consistent with the present disclosure. This method is generally labeled with numeral 206′, as it illustrates exemplary operations that may be performed by a server in accordance with secure distribution block 206 of FIG. 2. For the sake of discussion, it is assumed that the method will be implemented using a server that includes the components of server 102 as illustrated in FIG. 9.

As shown, the method begins a block 1010. At block 1011, computer readable instructions within a SERMM may cause the server to authenticate the client. Client authentication may be performed in a manner consistent with the authentication methods previously described, such as but not limited to the method of FIG. 8. The method may then proceed to block 1012, wherein the SERMM instructions may cause the server to determine whether client authentication was successful. If not, the method may proceed to block 1013, wherein the SERMM instructions may cause the server to determine whether a predetermined time period for authenticating the client has expired. If so, the method may proceed to block 1018 and end. If not, the method may loop back to block 1011, wherein client authentication may be attempted again.

If the client is authenticated, the method may proceed to block 1014, wherein the SERMM instructions may cause the server to monitor for receipt of a license request, e.g., over a secure communications channel with a client. The method may then proceed to block 1015, wherein the SERMM instructions may cause the server to make a determination as to whether a license request has been received. If not, the method may proceed to block 1016, wherein the SERMM instructions may cause the server to determine whether a predetermined time period for receiving a license request has expired. If so, the method may proceed to block 1018 and end. If not, the method may loop back to block 1014, wherein the server may continue to monitor for the receipt of a license request.

If a license request is received, the SERMM instructions may cause the server to provide the requested license to the client over a secure communications channel. Although not shown in FIG. 10B, the SERMM instructions may condition providing the license on verification that the client and/or a user thereof is authorized to access the license. In this regard, the SERMM instructions may cause the server to inspect an information access policy in the license for control parameters specifying which clients and/or users may have access to the license. If such control parameters exist in the information access policy, the SERMM instructions may cause the server to compare those parameters to identification indicia (e.g., client ID, user ID, etc.) included in messages from the client and/or associated with a client's whitelist identifier (which may be stored in database 314). If the identification indicia match relevant parameters in the information access policy, the SERMM instructions may permit the server to transfer the license to the client for sealing to the client's enclave.

Transfer of the license may occur using a secure communications channel between client 101 and server 102, which may be established in the manner discussed above or by another method. For example, the SERMM may cause the server to encrypt the license with a shared session key or the client's public key prior to transmitting the license to client. The client may decrypt the encrypted license with the shared session key or its private key, as appropriate. The client may then seal the plaintext of the license to its memory enclave, e,g., using an enclave key. The method may then proceed to block 1018 and end.

Once a license has been received and sealed to a memory enclave, the client may be use the license (or, more particularly, a decryption key in the license) to decrypt relevant encrypted digital information. By way of example, CEREM 901 may include instructions that when executed cause client 101 to unseal license 908 from memory enclave 304 using memory enclave 304's enclave key (E_{key}). Without limitation, license 908 is preferable unsealed within memory enclave 304, such that it may be protected from malware and other entities that may be resident on client 101. Once license 908 has been unsealed, CEREM 901 may cause client 101 to inspect the license for one or more keys for decrypting, the cipher text of digital information 907. If one or more decryption keys are found in the license, CEREM 901 may cause client 101 to use such key(s) to decrypt digital information 907 using an appropriate decryption protocol. As noted previously, the plaintext of digital information 907 may be preferably decrypted and stored within memory enclave 304, such that it too may be protected from malware or other entities.

In some embodiments the technologies of the present disclosure may utilize an information access policy to limit access to digital information provided to a client device. As described generally above, an information access policy may specify one or more control parameters that may govern access to relevant digital information. For example, an information access policy may include control parameters that limit digital information access to only authorized client platforms, authorized users of a client, combinations thereof, and the like. Alternatively or additionally, control parameters of an information access policy may limit digital information access to a specified time, for a specified time period, to a specified location, combinations thereof, and the like. Without limitation, information access policies described herein may be included in a license to digital information, or may be separately provisioned and/or stored. With this in mind, another aspect of the present disclosure therefore relates to technologies for hardening the security of information access policies and modules for enforcing the same.

In this regard reference is again made to FIG. 9, wherein CEREM 901 of client 101 is illustrated as further including policy enforcement module (PEM) 903, which may function to perform policy enforcement operations consistent with the present disclosure. Because PEM 903 is stored and executed within memory enclave 304, it may be protected from tampering by malware, users of client 101, and other entities.

As noted previously, license 908 may include an information access policy that includes control parameters governing access to digital information 907. In such instances, PEM 903 may be configured to cause client 101 to enforce those control parameters. By way of example, when CEREM 901 attempts to decrypt the cipher text of digital information 907, PEM 903 may cause client 101 to determine whether decryption of the cipher text is permitted. In instances where control parameters in the information access policy limit access to digital information 907 to specific client platforms, specific users, a specific time, etc., PEM 903 may cause client 101 to determine whether such control parameters are met. If one or more of the control parameters is not met, PEM 903 may prevent client 101 (or more particularly, CEREM 901) from decrypting the cipher text of digital information 907 using the decryption key(s) in license 908. If all of the control parameters in the information access are met however, PEM 903 may permit client 101 (or more particularly, CEREM 901) to decrypt the cipher text of digital information 907 and store/seal the resulting plaintext in or to memory enclave 304.

While the foregoing example describes a system and method wherein a client enforces an information access policy, client enforcement is not required. Indeed in some embodiments of the present disclosure, a device remote from the client (e.g. server 102) may enforce all or a portion of an information access policy. In such instances, license 908 may include one or more decryption keys for decrypting the cipher text of digital information 907, as well as an indicator that access to digital information 907 is governed by an information access policy resident on server 102. The indicator may also specify the type of information that may be needed by server 102 to enforce the relevant information access policy (e.g., client ID, user ID, etc.).

When CEREM 901 causes client 101 to attempt to decrypt digital information 907, PEM 903 may cause client 101 to communicate with a server policy enforcement module (SPEM; not shown) resident on server 102, e.g., using a secure communications channel. For example, PEM 903 may cause client 101 to send a policy enforcement message to server 102 over a secure communications channel. The policy enforcement message may include information that may have been specified in the indicator (e.g., client ID, user ID, etc.) present in the information access policy. In response to the policy enforcement message, the SPEM on server 102 may determine whether a relevant information access policy includes control parameters governing access to the digital information, and whether such parameters are met by the information included in the policy message.

If a relevant information access policy includes control parameters that are not satisfied by information in a policy enforcement message, server 102 may send an access denied message to client 101 over a secure communication channel, in response to which PEM 903 may prevent client 101 from decrypting digital information 907. If the control parameters specified in a relevant information access policy are met however, server 102 may send an access approved message to client 101 over the secure communications channel, in response to which PEM 903 may permit client 101 to decrypt digital information 907 using the key(s) provided in license 908.

In some embodiments a logging policy may be included in an information access policy or as a separate data structure. In either case the logging policy may include control parameters that require the logging of events associated with specified digital information. In such instances access to digital information may be conditioned on the successful initiation and enforcement of data logging. With the foregoing in mind, another aspect of the present disclosure relates to technologies for hardening the security of logging policies/code and activity data logs, as well as the execution of activity logging on a client device. Such technologies may use a secure environment such as may be provided by memory enclave technology to protect elements involved in activity logging on a client device.

For example, the clients of the present disclosure may be configured to store activity policies, logging code and/or activity logs within memory enclave 304 of client 101, such that they may be protected from malware. In some embodiments access to digital information on the client may be conditioned on successful initiation and/or execution of activity logging. In some instances a logging policy may required server logging, wherein activity logs stored on the client and/or activities associated with digital information are transferred to a remote server, e.g., to hinder or prevent their accidental deletion and/or replay. In such instances access to digital information may be conditioned on the successful initiation of server logging.

Referring again to FIG. 9, a logging policy may be included in license 908 or another data structure. In any case the logging policy may include one or more control parameters. The control parameters may for example require logging of various activities associated with digital information 907, such as failed/successful attempts, time of access, time of modification, time access was ceased, a digital information identifier, combinations thereof, and the like. The logging policy may also specify that recorded events are to be included in an activity log stored on the client, either alone or in association with the user ID and/or client ID connected with the activity. Alternatively or additionally, the logging policy may specify the use of server logging, in which activity logs produced by the enforcement of an activity on a client are transferred to a server and/or activities associated with specified digital information are reported to a server, e.g., over a secure channel as described above. The transfer of activity logs and/or the report of activities associated with digital information may occur a set number of times, at periodic intervals, at semi-random intervals, at random intervals, continuously, or a combination thereof. In any case, the information access policy in license 908 may condition access to digital information 907 on the successful execution of the logging policy.

The activity logging policy may further require recordation of the time of detected events associated with digital information. In such instances a trusted source of time may be used to ensure the accurate recording of the timing of detected events. In instances where server 102 is a trusted platform, it may serve as a trusted source of time for client 101. For example, server 102 may communicate the time to client 101 over a secure communications channel. Alternatively or additionally, client 101 may itself include a trusted source of time. For example, client 101 may include a trusted execution environment (TEE, not shown in FIG. 9), which may provide a trusted time to PEM 903 over a secure communications channel/pathway with memory enclave 304.

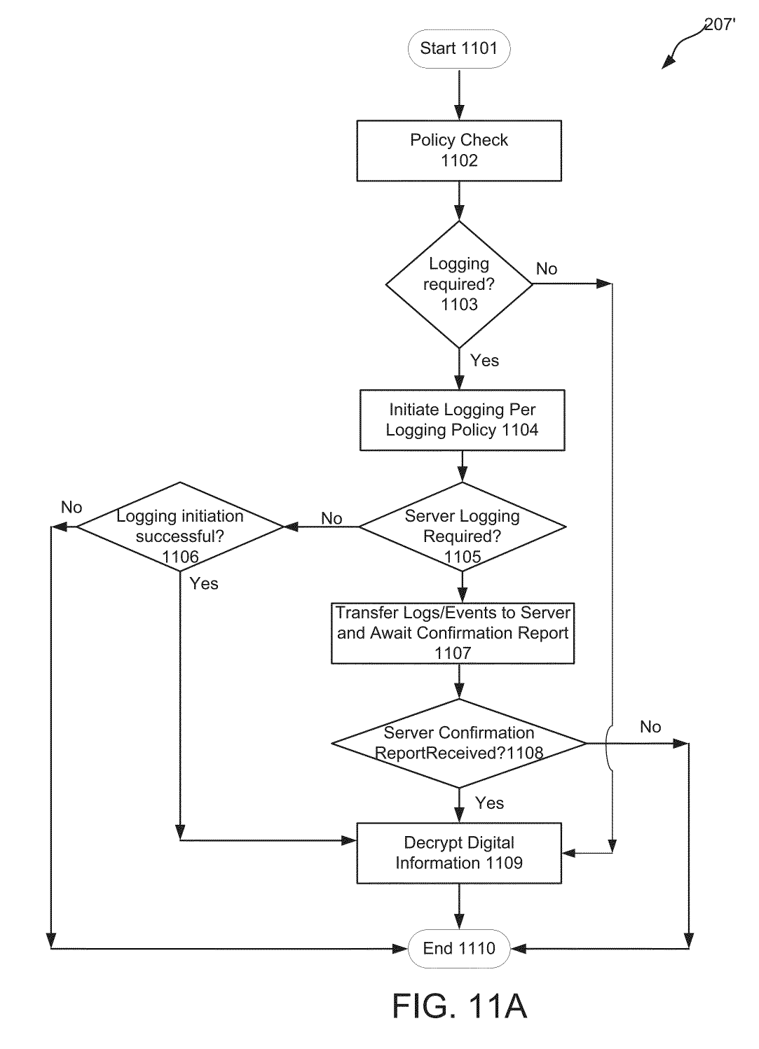

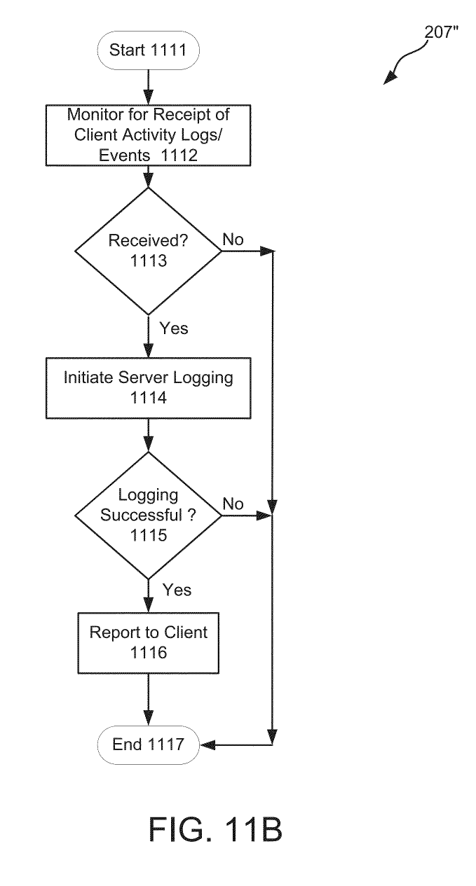

In operation, PEM 903 may condition access to digital information 907 on the successful initiation of activity logging consistent with the parameters specified in an activity logging policy. This concept is illustrated in FIG. 11A, which depicts activity logging enforcement operations that may be performed by a client in accordance an exemplary activity logging method consistent with the present disclosure. For clarity the method of FIG. 11A is generally labeled with numeral 207′, as it reflects exemplary operations that may be performed by a client in accordance with secure policy enforcement/logging block 207 of FIG. 2.

As shown, the method begins at block 1101. At block 1102, computer readable instructions within PEM 903 when executed may cause client 101 to inspect an information access policy governing access to digital information 907 for the presence of an activity logging policy. For the sake of discussion it is assumed that the information access policy was securely provisioned to client 101. The method may then proceed to block 1103, wherein PEM 903 may cause client 101 to determine whether the information access policy requires the enforcement of an activity logging policy with respect to digital information 907. If not and all other control parameters in the information access policy are satisfied, the method may proceed to block 1109, whereupon PEM 903 may permit CEREM 901 to decrypt digital information 907.

If activity logging is required, the method may proceed to block 1104, wherein PEM 903 may cause client 101 to initiate activity logging consistent the parameters specified in the activity logging policy. For example, the activity logging policy may specify the recordation of activities associated with digital information 907 in a client activity log, which may be stored within a memory enclave of the client. In such instance PEM 903 may cause client 101 to begin logging activities associated with digital information 907 by recording an initial log entry in a client activity log and storing such log in a memory enclave. This concept is illustrated in FIG. 9, wherein client activity log (CAL) 904 is shown as stored within memory enclave 304.

The activity logging policies described herein may require the initiation of server logging, as described above. With this in mind, the method of FIG. 11A may proceed to block 1105, wherein PEM 903 may cause client 101 to determine whether server logging is required. In some embodiments, client 101 may make this determination by inspecting the parameters in the activity logging policy.

If server logging is not required the method may proceed to block 1106, wherein PEM 903 may cause client 101 to determine whether logging initiation was successful. Client 101 may make this decision, for example, by analyzing log entries produced by execution PEM 903 (e.g., CAL 904) to determine whether they are consistent with the logging policy. If logging initiation was successful, the method may proceed to block 1109 wherein PEM 901 may permit CEREM 901 to decrypt digital information 907. If logging initiation was unsuccessful, the method may proceed from block 1106 to block 1110 and end.

If server logging is required, the method may proceed from block 1105 to block 1107, wherein PEM 903 may cause client 101 to transfer client activity logs (e.g., CAL 904) and/or to report events associated with digital information 907 to server 102. Without limitation, the activity logs and/or events are preferably transmitted from client 101 to server 102 over a secure communications channel, as discussed above. For example, client 101 may encrypt the activity logs with server 102's public key and/or with a shared session key. Server 102 may then decrypt the encrypted logs/events using its private key and/or the shared session key, as appropriate.

As will be discussed in connection with FIG. 11B, server enterprise rights management module (SERMM) 905 may in response to receiving such logs/events cause server 102 to create a server activity log (SAL). This concept is illustrated in FIG. 9, wherein server 102 is depicted as optionally including server activity log (SAL) 906. Without limitation, server activity log 906 may store client activity logs and/or events associated with digital information 907. If the creation of SAL 906 is successful, SERMM 905 may cause server 102 to send a confirmation report to client 101, indicating successful server logging. Without limitation, server 102 may preferably send confirmation r ports to client 101 over a secure communications channel, as discussed above.

Returning to FIG. 11A, PEM 903 may pursuant to block 1107 cause client 101 to monitor for receipt of a confirmation report from server 102, indicating that server logging has been successfully initiated. The method may proceed to block 1108, wherein PEM 903 may cause client 101 to determine whether a confirmation report from server 102 has been received. If a confirmation message was not received, the method may proceed to block 1110 and end. If a confirmation report was received, the method may proceed to block 1109, wherein PEM 903 may permit CEREM 901 to decrypt the cipher text of digital information 907.

Reference is now made to FIG. 11B, which is a flow diagram of server logging operations that may be performed by a server in an exemplary logging method consistent with the present disclosure. For the sake of this embodiment, it is assumed that server logging is required by an activity logging policy.

As shown, the method begins at block 1111. At block 1112, SERMM 905 when executed may cause server 102 to monitor for the receipt of client logs and/or events associated with digital information 907, e.g., from a secure communications channel with client 101. The method may then proceed to block 1113, wherein SERMM 905 may cause server 102 to determine whether client logs and/or events associated with digital information 907 have been received. If such logs/events have not been received, the method may proceed to block 1117 and end. If a client activity log and/or an event associated with digital information 907 has/have been received however, the method may proceed to block 1114.

SERMM 905 may pursuant to block 1114 cause server 102 to initiate server logging. For example, SERMM 905 may cause server 102 to instantiate a server activity log (SAL) such as optional SAL 906 in a memory thereof. The SAL may include client activity logs and/or events received from client 101, e.g. via a secure communications channel. The method may then proceed to block 1115, wherein SERMM 905 may cause server 102 to determine whether server logging has been successfully implemented. For example, SERMM 905 may have knowledge of the parameters specified by an activity logging policy with respect to server logging of events and/or client activity logs. In such instances SERMM 905 may cause client 101 to determine whether a server activity log instantiated in its memory meets the parameters specified in the activity logging policy.

If the server activity log does not meet the parameters specified in the activity logging policy, server logging may be considered unsuccessful. At this point, the method may proceed to block 1117 and end. In contrast, server logging may be considered successful if the server activity log meets the parameters specified in the activity logging policy. In that case the method may proceed to block 1116, where SERMM 905 may cause server 102 to send a confirmation report to client 101 over a secure communications channel. Once the confirmation report has been sent, the method may proceed to block 1117 and end.

As may be appreciated from the foregoing, the technologies of the present disclosure may harden the security and/or enforcement of activity logging policies, as well as activity logs that may be created by their enforcement. In particular, the technologies described herein may protect activity logging, enforcement code (e.g., included in PEM 903) by storing and executing it in a secure enclave of a client device. Likewise, activity logs produced by execution of the logging enforcement code may be stored within and protected by a secure enclave. Server activity logging may also be implemented to guard against the accidental tampering and/or deletion of the activity logging code and logs. Furthermore, communications between a client and server (e.g., to report activity logs/events) may be protected by encryption, e.g., using one or more public keys and/or a shared session key.

Once a client possesses encrypted digital information and one or more corresponding decryption keys, it may use the decryption key(s) to decrypt the encrypted information for viewing. One or more modules on the client may initiate decryption of the encrypted information. For example, CEREM 901, viewer module 902, a user interface component, or a combination thereof may initiate decryption. Without limitation, viewer module 902 preferably initiates decryption of encrypted digital information, and causes client 101 to store the plaintext of the digital information in memory enclave 304, as generally described above.

Once the digital information is decrypted, client 101 may process it for display. As noted previously, malware and other entities may be able to steal or otherwise access the plaintext of digital information as it is processed through the display pathway of a client device. With this in mind, another aspect of the present disclosure relates to technologies for protecting digital content as it processed for display on a client device, e.g., by leveraging the capabilities of one or more secure environments on a client device so as to protect digital information as it is accessed by and displayed on the client. More particularly, the technologies of the present disclosure may utilize secure enclave technology and protected audio video (PAV) technology to protect digital information as it is processed on a client for display.

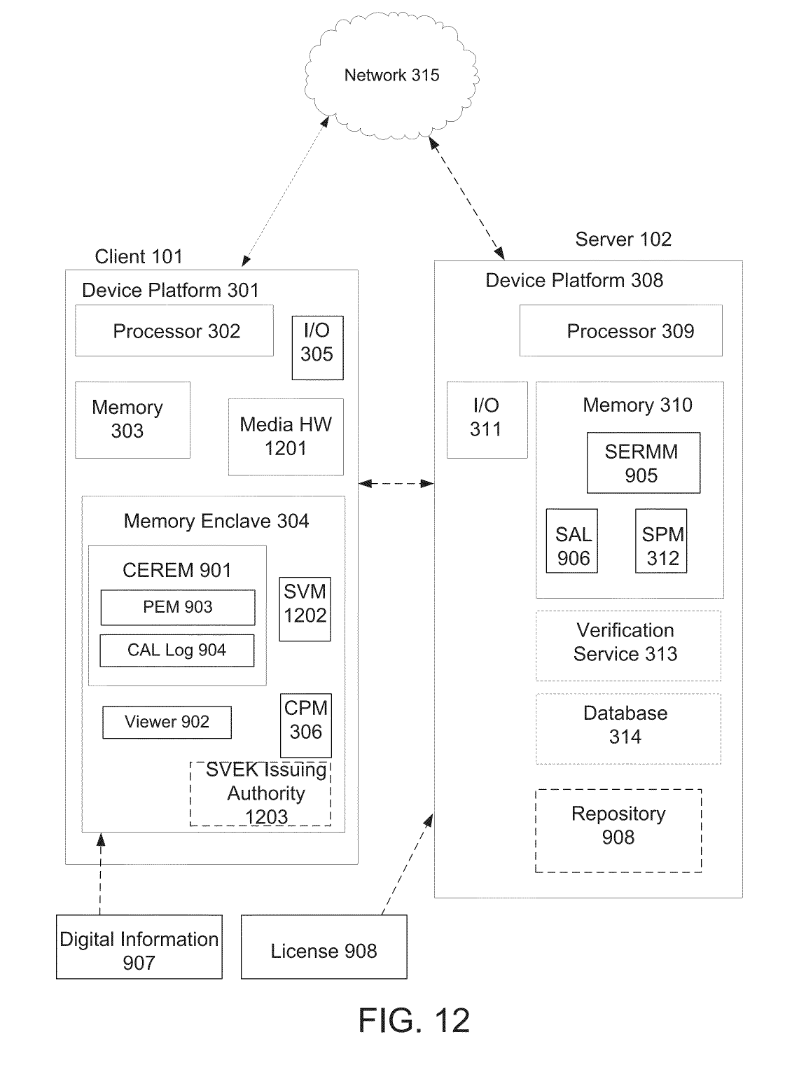

To further illustrate this concept reference is made to FIG. 12, which depicts exemplary system architecture of another ERM system consistent with the present disclosure. As shown, the system includes client 101, server 103, and network 315. The nature and function of many of the components of client 101 and server 102 is the same as the components of FIGS. 3 and 9 and for the sake of brevity will not be repeated. As also shown, client 101 may include media hardware (HW) 1201.

In general, media HW 1201 may be in the form of an integrated or separate graphics adaptor (e.g., a video card, graphics processing unit, etc.). Without limitation, media HW 1201 is preferably in the form of an integrated graphics processing unit, such as an Intel integrated graphics processing unit. Of course, the use of Intel integrated graphics is not required and any suitable media hardware may be used. For example, media HW 1201 may be in the form of a discrete graphics card, such as but not limited to the video cards produced by NVIDIA™ and Advanced Micro Devices (AMD™). Alternatively or additionally, media HW 1201 may be in the form of processor integrated graphics, such as but not limited to the processor integrated graphics found in the INTEL® Core™ i3, i5, and i7 lines of processors. In general, any media hardware may be used, so long as it is capable of rendering encrypted video frames, e.g., video frames that have been encrypted with a temporal secure video encryption key (SVEK), as described below.

The system may further include secure video module (SVM) 1202 and secure video encryption key (SVEK) issuing authority 1203. SVM 1202 may generally function to perform secure video processing operations, as discussed later. SVEK issuing authority 1203 may be provided within memory enclave 304, within another memory of client 101, as a separate module of client 101, and/or as part of a device other than client 101, as reflected by the hashed marking of this element. As will be described, SVEK issuing authority 1203 may generally function to perform authentication and temporal SVEK issuing functions consistent with the present disclosure. In some embodiments, SVEK issuing authority 1203 is in the form of a module that is stored and executed within a secure environment, such as a trusted execution environment, a memory enclave or a combination thereof. Alternatively or additionally, SVEK issuing authority 1203 may be in the form of a separate module.

For the sake of illustration the present disclosure will describe a use case in which the system of FIG. 12 may be used to protect digital information as it is processed for display one client 101. In this discussion it is assumed that client 101 has been provisioned with encrypted digital information 907 and a license 908 including a relevant decryption key. It is also assumed that memory enclave 304 has been provisioned with a secure video encryption (SVEK) private key. These items may have been distributed to client 101 using any suitable process, e.g., the secure provisioning and distribution processes discussed previously. Alternatively or additionally, a client enclave and the SVEK issuing authority may engage in an cryptographic protocol such as SIGMA to establish a shared SVEK private key for use in SVEK provisioning.

SVM 1202 may include computer readable instructions that when executed cause client 101 to decrypt digital information 907 using the decryption key(s) in license 908. Without limitation, SVM 1202 may cause client 101 to decrypt digital information 907 within memory enclave 304, such that the plaintext of digital information 907 may be protected from malware and other entities. Once digital information 907 is decrypted, SVM 1202 may further cause client 101 to perform secure video processing operations. As described below, the secure video operations may include generating a temporal secure video encryption key (SVEK), securely displaying digital information 907, or a combination thereof.

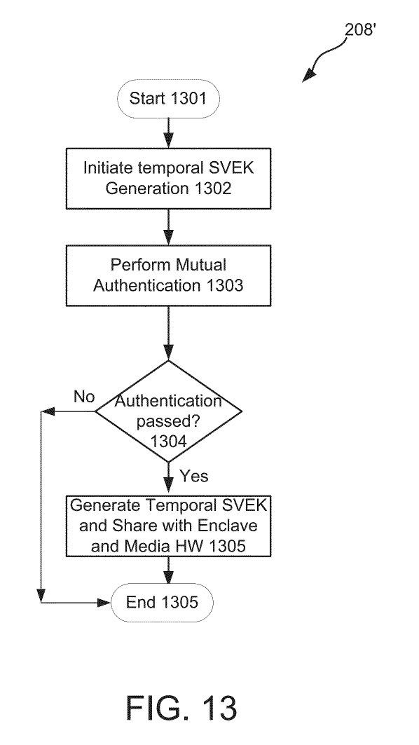

With respect to generating a temporal SVEK, reference is made to FIG. 13, which is flow diagram of an exemplary temporal SVEK generation method consistent with the present disclosure. This method is generally labeled 208′, as it reflects certain client operations that may be performed pursuant to secure viewing/interaction block 208 of FIG. 2.

As shown, the method begins at block 1301. At block 1302, the SVM instructions when executed may initiate temporal SVEK generation. In some embodiments, the SVM instructions may cause client 101 to issue and send a temporal SVEK generation message to an SVEK issuing authority, such as SVEK issuing authority 1203. Without limitation, the temporal SVEK generation message may include the SVEK private key as well as identifying indicia that may be used by the SVEK issuing authority to authenticate SVM 1202. By way of example, the temporal SVEK generation message may include a certificate of an independent software vendor that provided SVM 1202. In such instances, the SVEK issuing authority (e.g., a TEE such as Intel® Manageability Engine) may verify the authenticity of the SVM certificate by comparing it to a whitelist of SVM certificates of which it is aware. In this regard, the SVEK issuing authority may include memory storing a database including identifying indicia (e.g., SVM certificates) of approved SVM's.

In addition to authenticating the SVM, the SVEK issuing authority may also verify the authenticity of the media hardware of client 101, e,g., using a cryptographic protocol. Alternatively or additionally, a secure hardware pathway may exist between the media hardware and the SVEK issuing authority, in which case the authenticity of the the media hardware may be omitted.

The method may then proceed to block 1304, wherein the SVM instructions may cause client 101 to determine whether mutual authentication has succeeded or failed. In this regard, the SVEK issuing authority may issue authentication passed/failed messages to client 101 upon the successful/failed authentication of SVM 1202 and media HW 1201. Client 101 may inspect such messages to determine whether mutual authentication has succeeded or failed. If authentication of SVM 1202 or media HW 1201 fails, client 101 may determine that mutual authentication has failed and the method may proceed to block 1305 and end. If mutual authentication succeeds however, the method may proceed to block 1305.

Pursuant to block 1305, the SVEK issuing authority may generate a temporal SVEK in response to a temporal SVEK request, and may distribute the temporal SVEK to SVM 1202 and media HW 1201. Generation of the temporal SVEK by the SVEK issuing authority may occur in any suitable manner. For example, once much authentication succeeds, memory enclave 304 may send a temporal SVEK request to SVEK issuing authority 1203. The request message may be signed using the SVEK private key, thus allowing the SVEK issuing authority to verify its authenticity. In response to such a request, SVEK issuing authority 1203 may generate a temporal SVEK using a source of entropy such as random number generator. In any case, the temporal SVEK may be valid for a limited number of runs (e.g., one) of SVM 1201. Once the limited number of runs has expired, a new temporal SVEK may be generated by the SVEK issuing authority in the manner discussed above.

Once generated, the SVEK issuing authority may share the temporal SVEK with the SVM and the video HW of the client device. For example, SVEK issuing authority 1203 may then send the temporal SVEK key to SVM 1202 in a message encrypted using the SVEK private key. SVEK issuing authority 1203 may also send the temporal SVEK keys to Media HW 1201, e.g., over a secure communications channel and/or via a dedicated hardware path. Without limitation, the temporal SVEK is preferably securely stored (e.g., within memory enclave 304 or another secure location such as secure media memory) while it is active, such that it may be protected by the enclave (and/or secure media memory) against malware and other entities while it is active. Once the temporal SVEK has been generated and shared, the method may proceed to block 1305 and end.

The SVM and video HW of a client device may use a temporal SVEK to protect digital information as it is processed for display. Indeed as will be described below, SVM 1202 and media HW 1201 of the system of FIG. 12 may use the temporal SVEK in a symmetric key encryption protocol to encrypt and decrypt all or a portion of the plaintext of digital information 907 as it is processed through the display path of client 101. More specifically, SVM 1202 when executed may cause viewer 1202 to parse the plaintext of digital information 907 into raw frames or “pages” within enclave 304, which may be compatible with media HW 1201. For example, the raw frames may be in bitmap format, JPEG format, GIF format, TIFF format, another image file format, combinations thereof, and the like. Without limitation, the raw frames are preferably in bitmap format.

SVM 1202 may then cause client 101 to encrypt the raw frames with the temporal SVEK using a symmetric key encryption protocol. SVM 1202 may then cause client 101 to transfer (e.g., using an appropriate media (e.g., graphics) application program interface (API) and graphics driver) encrypted frames to media memory of media HW 1201, such as a media (e.g. video) buffer of media HW 1201. For example, SVM 1202 may cause client 101 to use a MICROSOFT® graphics processing unit computing group (GPUCP) API available before the filing date of this disclosure and an appropriate driver to transfer encrypted frames to media HW 1201.

In response to receiving encrypted frames, Media HW 1201 may decrypt the encrypted frames using the temporal SVEK. The raw frames resulting from such decryption may be stored in any suitable memory within media HW 1201, such as its media (e.g., video) buffer. Simultaneously with, substantially simultaneously with, or after such decryption, media HW 1201 may encrypt the raw frames using one or more encryption protocols, and output a signal including the resulting encrypted frames in a signal to a compatible display. For example, media HW 1201 may encrypt the raw frames using high bandwidth digital content protection (HDCP) or equivalent display output protection technology, and output the (HDCP) encrypted frames in a signal to a compatible display.

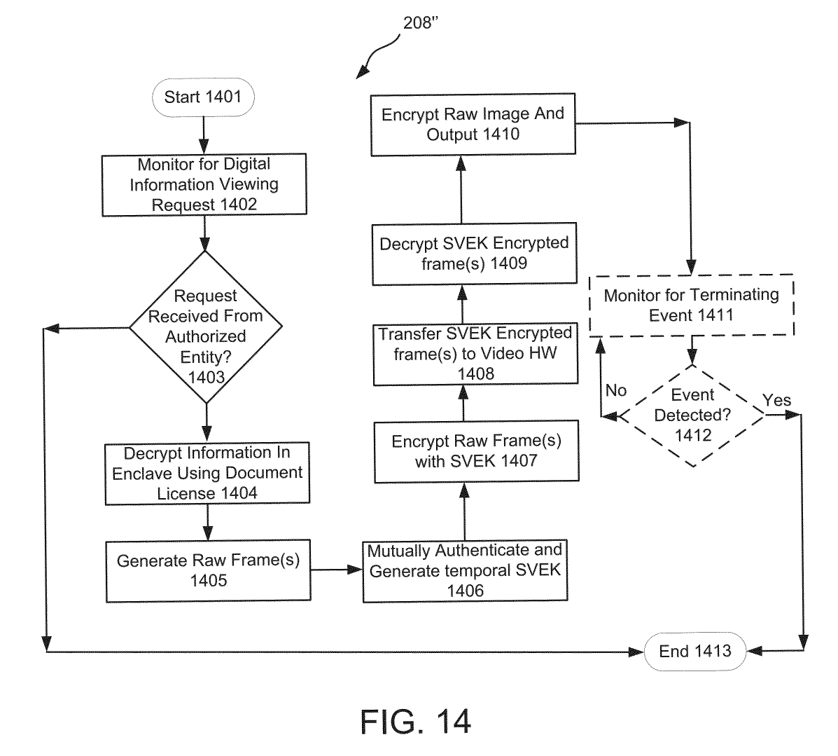

Reference is now made to FIG. 14, which is a flow diagram of an exemplary method of securing digital information through the display path of a client device consistent with the present disclosure. This method is generally labeled with the numeral 208″, as it illustrates various operations that may be performed pursuant to block 208 of FIG. 2. For the sake of discussion, the following description assumes the use of a client configured as shown in FIG. 12, and has been provisioned with encrypted digital information 907, a decryption key (e.g., in license 908), and a private secure video encryption key.

As shown, the method begins at block 1401. At block 1402, CEREM 901 may monitor for the issuance of a digital information viewing request. Viewer 902, SVM 1202 or another component may issue such request, e.g., in response to a user input through an interface. In any case, the method may proceed to block 1403, wherein CEREM 901 may determine whether the request was issued by an authorized entity. In general, CEREM 901 may make this determination by executing a policy enforcement module and/or method as generally described above. If the digital information viewing request was not issued by an authorized entity, the method may proceed to block 1414 and end. If the request was issued by an authorized entity however, the method may proceed to block 1404.

Pursuant to block 1404, CEREM 901 when executed may cause client 101 to decrypt encrypted digital information 907, e.g., using a decryption key contained in license 908. Without limitation, CEREM 901 preferably causes client 101 to decrypt encrypted digital information 907 within memory enclave 304, such that the plaintext of the digital information may be protected from malware. Once the plaintext of digital information 907 is obtained, the method may proceed to block 1405, wherein raw frame(s) of digital information 907 are produced. As discussed above, raw frames may be produced by the execution of viewer module 902, which may cause client 101 to parse the plaintext of digital information 907 into raw frames. Of course, other methods of generating raw frames may be used.

The method may then proceed to block 1406, wherein SVM 1202 initiates mutual authentication and temporal SVEK key generation by a SVEK key issuing authority. The operations pursuant to this block are substantially the same as described above in connection with FIG. 13, and thus are not reiterated.

Assuming mutual authentication completes successfully and a temporal SVEK is shared with SVM 1202 and media HW 1201, the method may proceed to block 1407. Pursuant to this block, SVM 1202 may cause client 101 to encrypt raw frames of digital information 907 using the temporal SVEK. The method may then proceed to block 1408, wherein SVM 1201 may cause client 101 to transfer the SVEK encrypted frames to Media HW 1201, as generally discussed above. Pursuant to block 1409, media HW 1201 may decrypt the SVEK encrypted frames. Simultaneously, near simultaneously, or subsequently, media HW 1201 may encrypt the resulting raw frame(s) pursuant to block 1410 be encrypted into an encrypted signal using another encryption protocol, such as HDCP. Media HW 1201 may then output the encrypted signal to a compatible display. For example, where the raw frames are processed into an HDCP encrypted signal, the video HW may output the encrypted signal to an HDCP compatible display.

The method may then proceed to block 1414 and end, or it may proceed through optional blocks 1411 and 1412. Pursuant to optional block 1411, SVM 1202 may cause client 101 to monitor for a terminating event. Non-limiting examples of terminating events include a power off condition, receipt of a termination signal, detection of tampering or unauthorized access to digital information 907, memory enclave 304 and/or its contents, combinations thereof, and the like. At optional block 1412, SVM 1202 may cause the client to make a determination as to whether a terminating event has been detected. If a terminating event has been detected, the method may proceed to block 1413 and end. If a terminating event has not been detected, the method may loop back to block 1411, wherein SVM 1202 may cause client 101 to continue to monitor for a terminating, event.

As may be appreciated from the foregoing, the technologies of the present disclosure may harden the security of digital information and assets that may be used to access digital information on a client device. Indeed in some embodiments, digital information and relevant assets may be sealed to and/or stored in a secure processing environment such as a memory enclave, such that they may be protected while at rest from malware and other malicious entities. When such assets are used, their plaintext may be secured at rest by a secure processing environment such as a secure enclave, and may be protected by encryption as it is transferred between components of a client device. As a result, such assets may be protected as they are provided on a client device, stored on a client device, used on a client device, and/or processed for display on a client device.

### EXAMPLES

Examples of the present disclosure include subject material such as a method, means for performing acts of the method, a device, at least one machine-readable medium, including instructions that when performed by a machine cause the machine to perform acts of the method, or of an apparatus or system for hardening the security of digital information and assets that may be used to access digital information on a client device, as discussed below.

### Example 1

According to this example there is provided a client device including a processor, a communication module to at least send and receive messages from a server device, and a secure processing environment to execute a client provisioning module (CPM) stored therein. The CPM is to at least: send a provisioning request message to the server device; receive a client white list identifier from the server device; and store or seal the client white list identifier in or to the secure processing environment.

### Example 2

This example includes the elements of example 1, wherein the secure processing environment is a memory enclave.

### Example 3

This examples includes the elements of examples 1 and/or 2, wherein the CPM is further to sign the provisioning request message with a first digital signature using a first digital signature key, wherein the first digital signature key is sealed to or stored in the secure processing environment and the authenticity of the first digital signature may be validated by the server.

### Example 4

This example includes the elements of any of examples 1, 2 or 3, wherein the first digital signature key is selected from a enhanced privacy identification (EPID key) of the client, a Rivest, Shamir, Adleman (RSA) signing key, or a combination thereof.

### Example 5

This example includes the elements of any of examples 1 to 4, and further includes a server public key, S_{pub}, sealed to or stored in the secure processing environment, S_{pub} being part of a server asymmetric key pair further including a server private key Sₚᵣᵢᵥ, wherein the client provisioning module is further to encrypt the provisioning request message with S_{pub}.

### Example 6

This example includes the elements of any of examples 1 to 5, wherein the CPM is further to verify the authenticity of a provisioning response message received from the server with S_{pub}, the provisioning response message being signed with Sₚᵣᵢᵥ.

### Example 7

This example includes the elements of any of examples 1 to 6, wherein the client provisioning module is further to generate a client asymmetric key pair including a client public key, C_{pub}, and a client private key, Cₚᵣᵢᵥ.

### Example 8

This example includes the elements of any of examples 1 to 7, and further includes identification information sealed to or stored in the secure processing environment.

### Example 9

This example includes the elements of any of examples 1 to 8, wherein the client identification information includes at least one of client anti-replay information, the client device's platform identification, user identification of one or more users of the client device, a security version number of the secure processing environment, an independent software vendor identification, a measurement of the secure processing environment, application specific identification information, and combinations thereof.

### Example 10

This example includes the elements of any of examples 1 to 9, wherein the CPM is further to generate a secure processing environment report, the secure processing environment report encapsulating C_{pub} and at least a portion of the client identification information.

### Example 11

This example includes the elements of any of examples 1 to 10, and further includes a quoting module, wherein: the CPM is further to provide the secure processing environment report to the quoting module; and the quoting module is to authenticate the secure processing environment and to generate a secure processing environment quote if the authentication succeeds, the secure processing environment quote including C_{pub} and at least a portion of the client identification information included in the secure processing environment report.

### Example 12

This example includes the elements of any of examples 1 to 11, wherein: the client provisioning module is further to transmit a quoting message including the secure processing environment quote to the server device; and the quoting message is to cause the server device to generate the white list identifier and to store the white list identifier in association with C_{pub} and the client identification information included in the secure processing quote.

### Example 13

This example includes the elements of any of examples 1 to 12, and further includes a second secure processing environment to store and execute the quoting module.

### Example 14

This example includes the elements of any of examples 1 to 13, wherein: the secure processing environment is a memory enclave; a second digital signature key is sealed to or stored in the memory enclave; and the CPM is further to sign the secure processing environment report with the second digital signature key.

### Example 15

This example includes the elements of any of examples 1 to 14, wherein the quoting module is further to verify the authenticity of the secure processing environment report using the second digital signature key.

### Example 16

This example includes the elements of any of examples 1 to 15, wherein the CPM is further to: generate a client asymmetric key pair including a client public key, C_{pub}, and a client private key, Cₚᵣᵢᵥ; transmit C_{pub} to a server; receive a server public key, S_{pub}, S_{pub} being part of a server asymmetric key pair that further includes a server private key, Sₚᵣᵢᵥ; and store or seal S_{pub} in or to the secure processing environment.

### Example 17

This example includes the elements of any of examples 1 to 15, and further includes a secure session establishment module (SSEM) to negotiate a secure session with the server using the white list identifier.

### Example 18

This example includes the elements of any of examples 1 to 17, wherein while the secure session is active, the client is configured to: encrypt client messages to the server device using S_{pub}; receive server messages encrypted with C_{pub} from the server device; and use Cₚᵣᵢᵥ to decrypt server messages encrypted with C_{pub} within the secure processing environment.

### Example 19

This example includes the elements of any of examples 1 to 18, wherein Cₚᵣᵢᵥ is stored on or sealed to the secure processing environment.

### Example 20

This example includes the elements of any of examples 1 to 19, wherein the SSEM negotiates a shared session key (SSK) with the server.

### Example 21

This example includes the elements of any of examples 1 to 20, wherein while the secure session is active, the client device is configured to: encrypt client messages to the server using the SSK; receive server messages encrypted with the SSK; and use the SSK to decrypt the server messages encrypted with the SSK within the secure processing environment.

### Example 22

Another example of the present disclosure relates to a method. The method includes: transmitting a provisioning request from a client device including a secure processing environment to a server device; receiving with the client device a white list identifier from the server device; and storing or sealing the white list identifier in or to the secure processing environment.

### Example 23

This example includes the elements of example 22, and further includes receiving with the client device a response message including server anti-replay information, and storing or sealing the server anti-replay information in or to the secure processing environment.

### Example 24

This example includes the elements of one of examples 22 and 23, wherein the response message is signed with a digital signature using a server private key, Sₚᵣᵢᵥ, the secure processing environment further includes a server public key, S_{pub}, stored therein or sealed thereto, and the method further includes validating with the client device the digital signature applied to the response message using S_{pub}.

### Example 25

This example includes the elements of any of examples 22-24, wherein the secure processing environment further includes at least a client public key, C_{pub}, and client identification information stored therein or sealed thereto, C_{pub} being part of a client asymmetric key pair that further includes a client private key, Cₚᵣᵢᵥ.

### Example 26

This example includes the elements of any of examples 22-25, wherein the client identification information includes at least one of client anti-replay information, the client device's platform identification, user identification of one or more users of the client device, a security version number of the secure processing environment, an independent software vendor identification, a measurement of the secure processing environment, application specific identification information, and combinations thereof.

### Example 27

This example includes the elements of any of examples 22-26, and further includes generating with the client device a secure processing environment report encapsulating C_{pub} and at least a portion of the client identification information.

### Example 28

This example includes the elements of any of examples 22-27, and further includes: sending the secure processing environment report to a quoting module, the quoting module executed within a second secure processing environment of the client device; verifying the authenticity of the secure processing environment report with the quoting module; and generating with the client device a secure processing environment quote, the secure processing environment quote including C_{pub} and at least a portion of the client identification information in the secure processing environment report.

### Example 29

This example includes the elements of any of examples 22-28, and further includes signing the secure processing environment quote with an enhanced privacy identification. (EPID) private key of the client.

### Example 30

This example includes the elements of any of examples 22-29 and further includes: generating with the client device a client asymmetric key pair including a client public key, C_{pub}, and a client private key, Cₚᵣᵢᵥ; transmitting C_{pub} to the server device; receiving a server public key, S_{pub}, with the client device. S_{pub} being part of a server asymmetric key pair that further includes a server private key, Sₚᵣᵢᵥ; and storing or sealing S_{pub} in or to the secure processing environment.

### Example 31

This example includes the elements of any of examples 22-30, and further includes storing or sealing Cₚᵣᵢᵥ in or to the secure processing environment.

### Example 32

This example includes the elements of any of examples 22-31, and further includes using the white list identifier to negotiate a secure session with the server device.

### Example 33

This example includes the elements of any of examples wherein while the secure session is active, the method further includes: encrypting with the client device client messages to the server with S_{pub}; receiving with the client device server messages encrypted with C_{pub}; using C_{pub}, decrypting with the client device server messages encrypted with Cₚᵣᵢᵥ to obtain the plaintext of the server messages; and storing or sealing the plaintext of the server messages in or to the secure processing environment.

### Example 34

This example includes the elements of any of examples 22-33, wherein the negotiating includes establishing a shared session key (SSK) for use in encrypting and decrypting client messages and server messages while the secure session is active.

### Example 35

This example includes the elements of any of examples 22-34, wherein while the secure session is active, the method further includes: encrypting with the client device client messages to the server using the SSK; receiving with the client device server messages encrypted with the SSK; using the SSK, decrypting with the client device server messages encrypted with the SSK to obtain the plaintext of the server messages within the secure processing environment; and storing or sealing the plaintext of the server messages in or to the secure processing environment.

### Example 36

Another example according to the present disclosure relates to a server device including a processor and a memory having a server provisioning module (SPM) stored thereon, the SPM to at least: receive a quoting message from a client device including a secure processing environment, the quoting message including client identification information and a client public key, C_{pub}, C_{pub} being part of a client asymmetric key pair further including a client private key, Cₚᵣᵢᵥ; verify the integrity and authenticity of the secure processing environment based at least in part on the client identification information; generate a white list identifier for the client device; store the white list identifier and at least a portion of the client identification information in a database of trusted client devices; and transmit the white list identifier to the client device.

### Example 37

This example includes the elements of example 36, wherein the quoting message includes an enclave quote that is signed with a digital signature, and the SPM is further to verify the authenticity of the digital signature using a digital signature verification protocol.

### Example 38

This example includes the elements of any of examples 36 and 37, wherein the digital signature is applied to the enclave quote using an enhanced privacy identification (EPID) private key of the client, a Rivest, Shamir, Adleman (RSA) signing key, or a combination thereof.

### Example 39

This example includes the elements of any of examples 36-38, wherein the client identification information includes at least one of client anti-replay information, the client device's platform identification, user identification of one or more users of the client device, a security version number of the secure processing environment, an independent software vendor identification, a measurement of the secure processing environment, application specific identification information, and combinations thereof.

### Example 40

This example includes the elements of any of examples 36-39, wherein the SPM is further to: receive a client provisioning request message encrypted with a server public key, S_{pub}, S_{pub} being part of a server asymmetric key pair further including a server private key, Sₚᵣᵢᵥ; and decrypt the client provisioning request message with Sₚᵣᵢᵥ.

### Example 41

This example includes the elements of any of examples 36-40, wherein the SPM is further to: receive a secure session establishment message from the client device, the secure session establishment message including at least the client white list identifier and a secure session request; determine whether the client device is acceptable for entering into a secure session based at least in part on the client white list identifier included in the secure session establishment request message; and negotiate a secured session with the client device if the client device is acceptable for entering into a secured session.

### Example 42

This example includes the elements of any of examples 36-41, wherein while the secured session is active, the server is configured to: encrypt server messages to the client using C_{pub}; receive client messages encrypted with a server public key, S_{pub}, S_{pub} being part of a server asymmetric key pair including a server private key, Sₚᵣᵢᵥ; and use Sₚᵣᵢᵥ to decrypt the client messages encrypted with S_{pub}.

### Example 43

This example includes the elements of any of examples 36-42, wherein while the secure session is active, the server is configured to: encrypt server messages to the client with a secure session key (SSK); receive client messages encrypted with the SSK; and use the SSK to decrypt the client messages encrypted with the SSK.

### Example 44

Another example of the present disclosure relates to a method including: receiving with a server device a quoting message from a client device including a secure processing environment, the quoting message including client identification information and a client public key, C_{pub}, C_{pub} being part of a client asymmetric key pair further including a client private key, Cₚᵣᵢᵥ; verifying with the server device the integrity and authenticity of the secure processing environment based at least in part on the client identification information; generating with the server device a white list identifier for the client device; storing the white list identifier, C_{pub}, and at least a portion of the client identification information in a database of trusted client devices; and transmitting the white list identifier to the client device.

### Example 45

This example includes the elements of example 44, and further includes transmitting with the server device a response message including server anti-replay information, the response message configured to cause the client device to store or seal the server anti-replay information in or to the secure processing environment.

### Example 46

This example includes the elements of any of examples 44 and 45, and further includes signing the response message with a digital signature using a server private key, Sₚᵣᵢᵥ, Sₚᵣᵢᵥ being part of a server asymmetric key pair further including a server public key, S_{pub}.

### Example 47

This example includes the elements of any of examples 44-46, wherein the client identification information includes at least one of client anti-replay information, the client device's platform identification, user identification of one or more users of the client device, a security version number of the secure processing environment, an independent software vendor identification, a measurement of the secure processing environment, application specific identification information, and combinations thereof.

### Example 48

This example includes the elements of any of examples 44-47, wherein the client identification information includes a measurement of the secure processing environment, the method further including validating the measurement of the secure processing environment with the server device against a database of approved secure processing environment measurements.

### Example 49

This example includes the elements of any of examples 44-48, wherein transmitting the client white list identifier is conditioned on the successful verification of the integrity and authenticity of the secure processing environment based at least in part on the client identification information.

### Example 50

This example includes the elements of any of examples 44-49, wherein the quoting message is signed with a digital signature, and verifying with the server device the integrity and authenticity of the secure processing environment includes validating the digital signature with the server device.

### Example 51

This example includes the elements of any of examples 44-50, and further includes: receiving with the server device a secure session establishment message from the client device, the secure session establishment message including the client white list ID and a secure session request: determining with the server device whether the client device is acceptable for entering into a secure session based at least in part on the client white list ID included in the secure session establishment message; and negotiating with the server device a secured session with the client device if the client device is acceptable for entering into a secured session.

### Example 52

This example includes the elements of any of examples 44-51, wherein white the secured session is active, the method further includes: encrypting with the server device server messages to the client device using the C_{pub}; receiving with the server device client messages encrypted with a server public key, S_{pub}, S_{pub} being part of a server asymmetric key pair including a server private key, Sₚᵣᵢᵥ; and using S_{priv,} decrypting with the server device the client messages encrypted with S_{pub}.

### Example 53

This example includes the elements of any of examples 44-52, wherein while the secure session is active, the method further includes: encrypting with the server device server messages to the client device with a secure session key (SSK); receiving with the server device client messages encrypted with the SSK; and using the SSK, decrypting with the server device the client messages encrypted with the SSK.

### Example 54

Another example of the present disclosure is a client device including: a processor; a memory having encrypted digital information stored thereon, the encrypted digital information being encrypted with at least one information encryption key; a secure processing environment having a client enterprise rights enforcement module (CEREM) stored therein, the CEREM to at least: request a license governing the encrypted digital information from a server device, the license including at least one information decryption key for decrypting the encrypted digital information; and store or seal the license in or to the secure processing environment.

### Example 55

This example includes the elements of example 54, wherein the CEREM is further to: decrypt the encrypted digital information using the at least one information decryption key so as to obtain plaintext of the digital information within the secure processing environment; and store or seal the plaintext of the digital information in or to the secure processing environment.

### Example 56

This example includes the elements of any of examples 54 and 55, wherein: the secure processing environment is a memory enclave including an enclave sealing key; and the CEREM seals the plaintext of the digital information to the secure processing environment using the enclave sealing key.

### Example 57

This example includes the elements of any of examples 54-56, wherein the secure processing environment further includes an interface module, the interface module to select the encrypted digital information and to cause the CEREM to request the license.

### Example 58

This example includes the elements of any of examples 54-57, wherein requesting the license includes sending a license request message to the server device over a secure communications channel established between the server device and the client device.

### Example 59

This example includes the elements of any of examples 54-58, wherein the CEREM is further to: encrypt the license request message with a shared session key (SSK), a server public key, S_{pub}, or a combination thereof to form an encrypted license request message, wherein: the encrypted license request message may be decrypted by the server device using the SSK, a server private key, Sₚᵣᵢᵥ corresponding to S_{pub}, or a combination thereof; and the SSK and S_{pub} are stored on or sealed to the secure processing environment.

### Example 60

Another example of the present disclosure is a client device including: a processor; a memory having encrypted digital information stored thereon, the encrypted digital information being encrypted with at least one information encryption key; a secure processing environment having a client enterprise rights enforcement module (CEREM) and license governing the encrypted digital information stored therein; and a policy enforcement module (PEM) within the secure processing environment, the PEM to enforce an information access policy that includes one or more control parameters governing access to the digital information; wherein the license includes at least one information decryption key for decrypting the encrypted digital information.

### Example 61

This example includes the elements of example 60, wherein the license includes the information access policy.

### Example 62

This example includes the elements of any of examples 60 and 61, wherein the control parameters limit access to the digital information to at least one of a predetermined list of authorized client devices, a predetermined list of authorized users of the client device, a predetermined length of time, a specified time period, and a specified location, wherein the PEM enforces the information access policy at least in part by enforcing the control parameters.

### Example 63

This example includes the elements of any of examples 60-62, wherein the PEM enforces the information access policy at least in part on a comparison of client identification information sealed to or stored on the secure processing environment to the control parameters.

### Example 64

This example includes the elements of any of examples 60-63, wherein the control parameters at least limit access to the digital information to a predetermined length of time, a specified time period, or a combination thereof, and the PEM enforces the information access policy at least in part on a comparison of time information received from the trusted source of time to the control parameters.

### Example 65

This example includes the elements of any of examples 60-64, wherein the trusted source of time is a trusted execution environment (TEE).

### Example 66

This example includes the elements of any of examples 60-65, wherein the PEM denies access to the digital information if at least one of the control parameters is not satisfied.

### Example 67

This example includes the elements of any of examples 60-66, wherein the PEM is to enforce an information access policy stored on a server device, wherein the license includes an indicator configured to signal the presence of the information access policy on the server device to the client device.

### Example 68

This example includes the elements of any of examples 60-67, wherein the PEM its further to send a policy enforcement message to the server device over a secure communications channel, the policy enforcement message including client information corresponding to one or more of the control parameters, the policy enforcement message configured to cause the server to enforce the information access policy based at least in part on a comparison of the client information to the control parameters.

### Example 69

This example includes the elements of any of examples 60-68, wherein the PEM further to: receive an access approved message from the server device if the control parameters are satisfied; permit the CEREM to decrypt the encrypted digital information using the at least one information decryption key so as to obtain plaintext of the digital information within the secure processing environment; and store or seal the plaintext of the digital information in or to the secure processing environment.

### Example 70

This example includes the elements of any of examples 60-69, wherein the PEM is further to: receive an access denied message from the server device if at least one of the control parameters is not satisfied; and prevent the CEREM from decrypting the encrypted digital information.

### Example 71

This example includes the elements of any of examples 60-70, wherein the one or more control parameters condition access to the digital information on the logging of events associated with the digital information.

### Example 72

This example includes the elements of any of examples 60-71, wherein the events include at least one of failed attempts to access the digital information, successful attempts to access the digital information, a time at which the digital information was accessed, a time at which the digital information was modified, a time at which the digital information was deleted, a time at which access to the digital information ceased, a number of times that the digital information was accessed, a number of times that the digital information was modified, and an identity of the digital information.

### Example 73

This example includes the elements of any of examples 60-72, wherein the one or more control parameters further condition access to the digital information on instantiation of an activity log within at least one of the secure processing environment of the client device and a memory of the server device, the activity log recording the events.

### Example 74

This example includes the elements of any of examples 60-73, wherein the one or more control parameters condition access to the digital information on the instantiation of the activity log on the server device, wherein the PEM is further to: send a server logging request to a server device over a secure communications channel between the server device and the client device; and receive a server report message from the server device, the server report message indicating successful or unsuccessful instantiation of the activity log in a memory of the server device.

### Example 75

This example includes the elements of any of examples 60-74, wherein the client device further includes a trusted source of time, wherein the PEM is further to record time information provided by the trusted source of time in association with the events in an activity log in the secure processing environment of the client device, in a memory of the server device, or a combination thereof.

### Example 76

Another example of the present disclosure is a client device including: a processor; a memory having encrypted digital information stored thereon, the encrypted digital information being encrypted with a first encryption protocol; a secure processing environment having a client enterprise rights enforcement module (CEREM) and a secure video module (SVM)s stored therein; and media hardware including a media memory; wherein: the CEREM is to decrypt the encrypted digital information with one or more decryption keys to obtain plaintext of the digital information within the secure processing environment; the SVM is to: encrypt the plaintext of the digital information using a second encryption protocol; and transmit the digital information encrypted with the second encryption protocol to media hardware; and the media hardware is to decrypt the digital information encrypted with the second encryption protocol to obtain the plaintext of the digital information within media memory, and to encrypt the plaintext within the media memory with a third encryption protocol to produce an encrypted media signal.

### Example 77

This example includes the elements of example 76, wherein the SVM is further to process the plaintext of the digital information in the secure processing environment into raw frames, to encrypt the raw frames using the second encryption protocol to produce encrypted frames, and to transmit the encrypted frames to the media hardware.

### Example 78

This example includes the elements of any of examples 76 and 77, wherein the media hardware is further to decrypt the encrypted frames to obtain the raw frames in the media memory, and to encrypt the raw frames in the media memory with the third encryption protocol to produce the encrypted media signal.

### Example 79

This example includes the elements of any of examples 76-78, and further includes a license sealed to the secure processing environment, the license including one or more decryption keys for decrypting the encrypted digital information, wherein the CEREM is to decrypt the encrypted digital information using the one or more decryption keys.

### Example 80

This example includes the elements of any of examples 76-79, and further includes a secure video encryption key (SVEK) sealed to or stored in the secure processing environment and the media memory, wherein: the SVM is to use the SVEK to encrypt the plaintext of the digital information within the secure processing environment to produce SVEK encrypted digital information, and to transmit the SVEK encrypted digital information to the media hardware; and the media hardware is to use the SVEK in the media memory to decrypt the SVEK encrypted digital information, so as to obtain the plaintext of the digital information within the media memory.

### Example 81

This example includes the elements of any of examples 76-80, and further includes an SVEK issuing authority, the SVEK issuing authority to generate the SVEK and transmit the SVEK to the secure processing environment and the media hardware.

### Example 82

This example includes the elements of any of examples 76-81, wherein the SVEK is a temporal SVEK.

### Example 83

This example includes the elements of any of examples 76-82, wherein the second encryption protocol is a Protected Audio Video Path (PAVP) protocol.

### Example 84

This example includes the elements of any of examples 76-83, wherein the third encryption protocol is a High-bandwidth Digital Content Protection (HDCP) protocol.

### Example 85

Another example of the present disclosure is a method including: issuing a license request message to a server device from a client device including a secure processing environment, the license request message including a request for a license to encrypted digital information stored on the client device, the license including one or more decryption keys for decrypting the encrypted digital information; receiving the license from server device over a secure communications channel between the client device and the server device; decrypting the encrypted digital information with the one or more decryption keys to obtain plaintext of the digital information; and storing or sealing the plaintext in or to the secure processing environment.

### Example 86

This example includes the elements of example 85, wherein the secure processing environment is a memory enclave including an enclave sealing key, and the method further includes sealing the plaintext of the digital information to the secure processing environment with the enclave sealing key.

### Example 87

This example includes the elements of any of examples 85 and 86, and further includes selecting the encrypted digital information with n interface module to initiate the issuance of the license request message.

### Example 88

This example includes the elements of any of examples 85-87, and further includes transmitting the license request message to the server device over the secure communications channel. Example 89

This example includes the elements of any of examples 85-88, and further includes: encrypting the license request message with a shared session key (SSK), a server public key, S_{pub}, or a combination thereof to form an encrypted license request message, wherein: the encrypted license request message may be decrypted by the server device using the SSK, a server private key, Sₚᵣᵢᵥ, corresponding to S_{pub}, or a combination thereof; and the SSK and S_{pub} are stored on or sealed to the secure processing environment.

### Example 90

Another example of the present disclosure is a method including: storing encrypted digital information on a client device, the client device including a secure processing environment; enforcing an information access policy that includes one or more control parameters governing access to the digital information; decrypting the encrypted digital information within the secure processing environment if the control parameters are met; and denying access to the encrypted digital information if at least one of the control parameters is not met.

### Example 91

This example includes the elements of example 90, wherein the encrypted digital information is encrypted with an encryption protocol using at least one information encryption key, the method further including: receiving a license to the digital information over a secure communications channel, the license including at least one information decryption key for decrypting the encrypted digital information; and sealing the license to the secure processing environment.

### Example 92

This example includes the elements of any of examples 90 and 91, and further includes: unsealing the license within the secure processing environment if the control parameters are met; decrypting the encrypted digital information with the information decryption key to obtain the plaintext of the digital information within the secure processing environment.

### Example 93

This example includes the elements of any of examples 90-92, wherein the license includes the information access policy.

### Example 94

This example includes the elements of any of examples 90-93, wherein the control parameters limit access to the digital information to at least one of a predetermined list of authorized client devices, a predetermined list of authorized users of the client device, a predetermined length of time, a specified time period, and a specified location, wherein the PEM enforces the information access policy at least in part by enforcing the control parameters.

### Example 95

This example includes the elements of any of examples 90-94, wherein enforcing the information access policy is performed at least in part by comparing client identification information sealed to or stored on the secure processing environment to the control parameters.

### Example 96

This example includes the elements of any of examples 90-95, wherein the control parameters at least limit access to the digital information to a predetermined length of time, a specified time period, or a combination thereof, the method further including: receiving time information from a trusted source of time; enforcing the information access policy is performed at least in part by comparing the of time information provided by the trusted source of time to the control parameters.

### Example 97

This example includes the elements of any of examples 90-96, wherein the trusted source of time is a trusted execution environment (TEE).

### Example 98

This example includes the elements of any of examples 90-97, wherein the information access policy is stored on a server device and the license includes an indicator to signal the presence of the information access policy on the server device to the client device, the method further including: processing the license with the client device to identify the indicator; transmitting a policy enforcement message to the server device over a secure communications channel, the policy enforcement message including client information corresponding to one or more of the control parameters, the policy enforcement message configured to cause the server to enforce the information access policy based at least in part on a comparison of the client information to the control parameters.

### Example 99

This example includes the elements of any of examples 90-98, and further includes receiving with the client device an access approved message from the server device if the control parameters are satisfied.

### Example 100

This example includes the elements of any of examples 90-99 and further includes receiving with the client device an access denied message from the server device if at least one of the control parameters is not satisfied.

### Example 101

This example includes the elements of any of examples 90-100, wherein the one or more control parameters condition access to the digital information on the logging of events associated with the digital information.

### Example 102

This example includes the elements of any of examples 90-101, wherein the events include at least one of failed attempts to access the digital information, successful attempts to access the digital information, a time at which the digital information was accessed, a time at which the digital information was modified, a time at which the digital information was deleted, a time at which access to the digital information ceased, a number of times that the digital information was accessed, a number of times that the digital information was modified, and an identity of the digital information.

### Example 103

This example includes the elements of any of examples 90-102, and further includes: instantiating an activity log within at least one of the secure processing environment of the client device and a memory of the server device, the activity log recording events associated with the digital information; and conditioning access to the digital information with the control parameters on successful instantiation of the activity log.

### Example 104

This example includes the elements of any of examples 90-103, wherein the one or more control parameters condition access to the digital information on successful instantiation of the activity log on the server device, the method further including: sending a server logging request from the client to a server device over a secure communications channel; and receiving a server report message from the server device over the secure communications channel, the server report message indicating successful or unsuccessful instantiation of the activity log in a memory of the server device.

### Example 105

This example includes the elements of any of examples 90-104, wherein the client device further includes a trusted source of time, wherein the method further includes: receiving with the client device time information from the trusted source of time; and recording the time information in association with events associated with the digital information in an activity log, the activity log being stored in the secure processing environment of the client device, in a memory of the server device, or a combination thereof.

### Example 106

Another example of the present disclosure is a method including: decrypting encrypted digital information to obtain plaintext of the digital information within a secure processing environment of a client device, the encrypted information being stored on the client device and encrypted with a first encryption protocol; encrypting the plaintext of the digital information using a second encryption protocol; transmitting the digital information encrypted with the second encryption protocol to media hardware of the client device;

decrypting the digital information encrypted with the second encryption protocol to obtain the plaintext of the digital information within a media memory of the media hardware; and encrypting the plaintext within the media memory with a third encryption protocol to produce an encrypted media signal.

### Example 107

This example includes the elements of example 106, and further includes: processing the plaintext of the digital information in the secure processing environment into raw frames; encrypting the raw frames within the secure processing environment to produce encrypted frames; and transmitting the encrypted frames to the media hardware.

### Example 108

This example includes the elements of any of examples 106 and 107, and further includes: decrypting the encrypted frames with the media hardware obtain the raw frames in the media memory; and encrypting the raw frames in the media memory with the third encryption protocol to produce the encrypted media signal.

### Example 109

This example includes the elements of any of examples 106-108, and further includes decrypting the encrypted digital information with one or more decryption keys in a license sealed to the secure processing environment, so as to obtain the plaintext of the digital information within the secure processing environment.

### Example 110

This example includes the elements of any of examples 106-109, wherein a secure video encryption key (SVEK) is stored in the secure processing environment and the media memory, the method further including: using the SVEK in the second encryption protocol to encrypt the plaintext of the digital information within the secure processing environment to produce SVEK encrypted digital information; transmitting the SVEK encrypted digital information to the media hardware; and decrypting the SVEK encrypted digital information with the media hardware using the SVEK in the media memory, so as to obtain the plaintext of the digital information within the media memory.

### Example 111

This example includes the elements of any of examples 106-110, wherein the client device further includes an SVEK issuing authority, the method further including: generating an SVEK with the SVEK issuing authority; and transmitting the SVEK from the SVEK issuing authority to the secure processing environment and the media hardware.

### Example 112

This example includes the elements of any of examples 106-111, wherein the SVEK is a temporal SVEK

### Example 113

This example includes the elements of any of examples 106-112, wherein the second encryption protocol is a Protected Audio Video Path (PAVP) protocol.

### Example 114

This example includes the elements of any of examples 106-112, wherein the third encryption protocol is a High-bandwidth Digital Content Protection (HDCP) protocol.

### Example 115

Another example of the present disclosure is a system including at least one device, wherein the system is arranged to perform the method of any of examples 22-35, 44-53, 85-89, 90-105, and 106-114.

### Example 116

Another example of the present disclosure is a chipset arranged to perform the method of any of examples 22-35, 44-53, 85-89, 90-105, and 106-114.

### Example 117

Another example of the present disclosure is at least one machine readable medium including a plurality of instructions that, in response to be being executed on a computing device, cause the computing device to carry out the method of any of examples 22-35, 44-53, 85-89, 90-105, and 106-114.

### Example 118

Another example of the present disclosure is a device configured for use with an electronic rights management system, the device being arranged to carry out the method of any of examples 22-35, 44-53, 85-89, 90-105, and 106-114.

### Example 119

Another example of the present disclosure is a device including means to carry out the method of any of examples 22-35, 44-53, 85-89, 90-105, and 106-114.

### Example 120

Another example of the present disclosure is a at least one machine readable storage medium having stored thereon, individually or in combination, instructions that when executed by at least one processor result in the following operations including: issuing a license request message to a server device from a client device including a secure processing environment, the license request message including a request for a license to encrypted digital information stored on the client device, the license including one or more decryption keys for decrypting the encrypted digital information; receiving the license from server device over a secure communications channel between the client device and the server device; decrypting the encrypted digital information with the one or more decryption keys to obtain plaintext of the digital information; and storing or sealing the plaintext in or to the secure processing environment.

### Example 121

This example includes the elements of example 120, wherein the secure processing environment is a memory enclave including an enclave sealing key, and the instructions when executed further result in the following operations including: sealing the plaintext of the digital information to the secure processing environment with the enclave sealing key.

### Example 122

This example includes the elements of any of examples 120 and 121, wherein the instructions when executed further result in the following operations including: selecting the encrypted digital information with an interface module to initiate the issuance of the license request message.

### Example 123

This example includes the elements of any of examples 120-122, wherein the instructions when executed further result in the following operations including: transmitting the license request message to the server device over the secure communications channel.

### Example 124

This example includes the elements of any of examples 120-123, wherein the instructions when executed further result in the following operations including: encrypting the license request message with a shared session key (SSK), a server public key, S_{pub}, or a combination thereof to form an encrypted license request message that may be decrypted by the server device using the SSK, a server private key, Sₚᵣᵢᵥ, corresponding to S_{pub}, or a combination thereof; and the SSK and S_{pub} are stored on or sealed to the secure processing environment.

### Example 125

Another example of the present disclosure is at least one machine readable storage medium having stored thereon, individually or in combination, instructions that when executed by at least one processor result in the following operations including: storing encrypted digital information on a client device, the client device including a secure processing environment; enforcing an information access policy that includes one or more control parameters governing access to the digital information; decrypting the encrypted digital information within the secure processing environment if the control parameters are met; and denying, access to the encrypted digital information if at least one of the control parameters is not met.

### Example 126

This example includes the elements of example 125, wherein the encrypted digital information is encrypted with an encryption protocol using at least one information encryption key, and the instructions when executed further result in the following operations including: receiving a license to the digital information over a secure communications channel, the license including at least one information decryption key for decrypting the encrypted digital information; and sealing the license to the secure processing environment.

### Example 127

This example includes the elements of any of examples 125 and 126, wherein the instructions when executed further result in the following operations including: unsealing the license within the secure processing environment if the control parameters are met; decrypting the encrypted digital information with the information decryption key to obtain the plaintext of the digital information within the secure processing environment.

### Example 128

This example includes the elements of any of examples 125-127, wherein the license includes the information access policy.

### Example 129

This example includes the elements of any of examples 125-128, wherein the control parameters limit access to the digital information to at least one of a predetermined list of authorized client devices, a predetermined list of authorized users of the client device, a predetermined length of time, a specified time period, and a specified location, and the instructions when executed further result in the following operation including: enforcing the information access policy at least in part by enforcing the control parameters.

### Example 130

This example includes the elements of any of examples 125-129, wherein the instructions when executed further result in the following operations including: enforcing the information access policy at least in part by comparing client identification information sealed to or stored on the secure processing environment to the control parameters.

### Example 131

This example includes the elements of any of examples 125-130, wherein the control parameters at least limit access to the digital information to a predetermined length of time, a specified time period, or a combination thereof, wherein the instructions when executed further result in the following operations including: receiving time information from a trusted source of time; enforcing the information access policy is performed at least in part by comparing the of time information provided by the trusted source of time to the control parameters.

### Example 132

This example includes the elements of any of examples 125-131, wherein the trusted source of time is a trusted execution environment (TEE).

### Example 133

This example includes the elements of any of examples 125-132, wherein the information access policy is stored on a server device and the license includes an indicator to signal the presence of the information access policy on the server device to the client device, and the instructions when further executed result in the following operations including: processing the license with the client device to identify the indicator; transmitting a policy enforcement message to the server device over a secure communications channel, the policy enforcement message including client information corresponding to one or more of the control parameters, the policy enforcement message configured to cause the server to enforce the information access policy based at least in part on a comparison of the client information to the control parameters.

### Example 134

This example includes the elements of any of examples 125-133, wherein the instructions when executed further result in the following operations including: receiving with the client device an access approved message from the server device if the control parameters are satisfied.

### Example 135

This example includes the elements of any of examples 125-134, wherein the instructions when executed further result in the following operations including: receiving with the client device an access denied message from the server device if at least one of the control parameters is not satisfied.

### Example 136

This example includes the elements of any of examples 125-135, wherein the one or more control parameters condition access to the digital information on the logging of events associated with the digital information.

### Example 137

This example includes the elements of any of examples 125-136, wherein the events include at least one of failed attempts to access the digital information, successful attempts to access the digital information, a time at which the digital information was accessed, a time at which the digital information was modified, a time at which the digital information was deleted, a time at which access to the digital information ceased, a number of times that the digital information was accessed, a number of times that the digital information was modified, and an identity of the digital information.

### Example 138

This example includes the elements of any of examples 125-137, wherein the instructions when executed further result in the following operations including: instantiating an activity log within at least one of the secure processing environment of the client device and a memory of the server device, the activity log recording events associated with the digital information; and conditioning access to the digital information with the control parameters on successful instantiation of the activity log.

### Example 139

This example includes the elements of any of examples 125-138, wherein the one or more control parameters condition access to the digital information on successful instantiation of the activity log on the server device, and the instructions when executed further result in the following operations including: sending a server logging request from the client to a server device over a secure communications channel; and receiving a server report message from the server device over the secure communications channel, the server report message indicating successful or unsuccessful instantiation of the activity log in a memory of the server device.

### Example 140

This example includes the elements of any of examples 125-139, wherein the client device further includes a trusted source of time, and the instructions when executed further result in the following operations including: receiving with the client device time information from the trusted source of time; and recording the time information in association with events associated with the digital information in an activity log, the activity log being stored in the secure processing environment of the client device, in a memory of the server device, or a combination thereof.

### Example 141

Another example of the present disclosure is at least one machine readable storage medium having stored thereon, individually or in combination, instructions that when executed by at least one processor result in the following operations including: decrypting encrypted digital information to obtain plaintext of the digital information within a secure processing environment of a client device, the encrypted information being stored on the client device and encrypted with a first encryption protocol; encrypting the plaintext of the digital information using a second encryption protocol; transmitting the digital information encrypted with the second encryption protocol to media hardware of the client device;

decrypting the digital information encrypted with the second encryption protocol to obtain the plaintext of the digital information within a media memory of the media hardware; encrypting the plaintext within the media memory with a third encryption protocol to produce an encrypted media signal.

### Example 142

This example includes the elements of example 141, wherein the instructions when executed further result in the following operations including: processing the plaintext of the digital information in the secure processing environment into raw frames; encrypting the raw frames within the secure processing environment to produce encrypted frames; and transmitting the encrypted frames to the media hardware.

### Example 143

This example includes the elements of any of examples 141 and 142, wherein the instructions when executed further result in the following operations including: decrypting the encrypted frames with the media hardware obtain the raw frames in the media memory; encrypting the raw frames in the media memory with the third encryption protocol to produce the encrypted media signal.

### Example 144

This example includes the elements of any of examples 141-143, wherein the instructions when executed further result in the following operations including: decrypting the encrypted digital information with one or more decryption keys in a license sealed to the secure processing environment, so as to obtain the plain text of the digital information within the secure processing environment.

### Example 145

This example includes the elements of any of examples 141-144, wherein a secure video encryption key (SVEK) is stored in the secure processing environment and the media memory, wherein the instructions when executed further result in the following operations including: using the SVEK in the second encryption protocol to encrypt the plaintext of the information within the secure processing environment to produce SVEK encrypted digital information; transmitting the SVEK encrypted digital information to the media hardware; and decrypting the SVEK encrypted digital information with the media hardware using the SVEK in the media memory, so as to obtain the plaintext of the digital information within the media memory.

### Example 146

This example includes the elements of any of examples 141-145, wherein the instructions when executed further result in the following operations including: generating an SVEK with the SVEK issuing authority of the client device and transmitting the SVEK from the SVEK issuing authority to the secure processing environment and the media hardware.

### Example 147

This example includes the elements of any of examples 141-146, wherein the SVEK is a temporal SVEK.

### Example 148

This example includes the elements of any of examples 141-147 wherein the second encryption protocol is a Protected Audio Video Path (PAVP) protocol.

### Example 149

This example includes the elements of any of examples 141-148,

Another example machine readable storage medium of the present disclosure includes any or all of the foregoing elements, wherein the third encryption protocol is a High-bandwidth Digital Content Protection (HDCP) protocol.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-99. (canceled)

100. A client device, comprising: a processor; a memory having encrypted digital information stored thereon, the encrypted digital information being encrypted with a first encryption protocol; a secure processing environment having a client enterprise rights enforcement module (CEREM) and a secure video module (SVM)s stored therein; and media hardware comprising a media memory; wherein: the CEREM is to decrypt said encrypted digital information with one or more decryption keys to obtain plaintext of said digital information within said secure processing environment; said SVM is to: encrypt said plaintext of said digital information using a second encryption protocol; and transmit the digital information encrypted with said second encryption protocol to media hardware; and the media hardware is to decrypt the digital information encrypted with said second encryption protocol to obtain the plaintext of said digital information within media memory, and to encrypt said plaintext within said media memory with a third encryption protocol to produce an encrypted media signal.

101. The client device of claim 100, wherein said SVM is further to process said plaintext of said digital information in said secure processing environment into raw frames, to encrypt said raw frames using said second encryption protocol to produce encrypted frames, and to transmit said encrypted frames to said media hardware.

102. The client device of claim 101, wherein said media hardware is further to decrypt said encrypted frames to obtain said raw frames in said media memory, and to encrypt said raw frames in said media memory with said third encryption protocol to produce said encrypted media signal.

103. The client device of claim 100, further comprising a license sealed to said secure processing environment, the license comprising one or more decryption keys for decrypting said encrypted digital information, wherein the CEREM is to decrypt said encrypted digital information using said one or more decryption keys.

104. The client device of claim 100, further comprising a secure video encryption key (SVEK) sealed to or stored in said secure processing environment and said media memory, wherein:
said SVM is to use said SVEK to encrypt said plaintext of said digital information within said secure processing environment to produce SVEK encrypted digital information, and to transmit said SVEK encrypted digital information to said media hardware; and
said media hardware is to use said SVEK in said media memory to decrypt said SVEK encrypted digital information, so as to obtain said plaintext of said digital information within said media memory.

105. The client device of claim 104, further comprising an SVEK issuing authority, the SVEK issuing authority to generate said SVEK and transmit said SVEK to said secure processing environment and said media hardware.

106. The client device of claim 104 wherein said SVEK is a temporal SVEK.

107. A method, comprising: decrypting encrypted digital information to obtain plaintext of said digital information within a secure processing environment of a client device, the encrypted information being stored on said client device and encrypted with a first encryption protocol; encrypting said plaintext of said digital information using a second encryption protocol; transmitting the digital information encrypted with the second encryption protocol to media hardware of said client device; decrypting the digital information encrypted with said second encryption protocol to obtain the plaintext of said digital information within a media memory of said media hardware; and encrypting said plaintext within said media memory with a third encryption protocol to produce an encrypted media signal.

108. The method of claim 107, further comprising:
processing said plaintext of said digital information in said secure processing environment into raw frames;
encrypting said raw frames within said secure processing environment to produce encrypted frames; and
transmitting said encrypted frames to said media hardware.

109. The method of claim 108, further comprising:
decrypting said encrypted frames with said media hardware obtain said raw frames in said media memory; and
encrypting said raw frames in said media memory with said third encryption protocol to produce said encrypted media signal.

110. The method of claim 107, further comprising decrypting said encrypted digital information with one or more decryption keys in a license sealed to said secure processing environment, so as to obtain said plaintext of said digital information within said secure processing environment.

111. The method of claim 107, wherein a secure video encryption key (SVEK) is stored in said secure processing environment and said media memory, the method further comprising:
using said SVEK in said second encryption protocol to encrypt said plaintext of said digital information within said secure processing environment to produce SVEK encrypted digital information;
transmitting said SVEK encrypted digital information to said media hardware; and
decrypting said SVEK encrypted digital information with said media hardware using said SVEK in said media memory, so as to obtain said plaintext of said digital information within said media memory.

112. The method of claim 111, wherein the client device further comprises an SVEK issuing authority, the method further comprising:
generating an SVEK with said SVEK issuing authority; and
transmitting said SVEK from said SVEK issuing authority to said secure processing environment and said media hardware.

113. At least one machine readable storage medium having stored thereon, individually or in combination, instructions that when executed by at least one processor result in the following operations comprising: decrypting encrypted digital information to obtain plaintext of said digital information within a secure processing environment of a client device, the encrypted information being stored on said client device and encrypted with a first encryption protocol; encrypting said plaintext of said digital information using a second encryption protocol; transmitting the digital information encrypted with the second encryption protocol to media hardware of said client device; decrypting the digital information encrypted with said second encryption protocol to obtain the plaintext of said digital information within a media memory of said media hardware; encrypting said plaintext within said media memory with a third encryption protocol to produce an encrypted media signal.

114. The at least one computer readable storage medium of claim 113, wherein said instructions when executed further result in the following operations comprising:
processing said plaintext of said digital information in said secure processing environment into raw frames;
encrypting said raw frames within said secure processing environment to produce encrypted frames; and
transmitting said encrypted frames to said media hardware.

115. The at least one computer readable storage medium of claim 114, wherein said instructions when executed further result in the following operations comprising:
decrypting said encrypted frames with said media hardware obtain said raw frames in said media memory;
encrypting said raw frames in said media memory with said third encryption protocol to produce said encrypted media signal.

116. The at least one computer readable storage medium of claim 113, wherein said instructions when executed further result in the following operations comprising:
decrypting said encrypted digital information with one or more decryption keys in a license sealed to said secure processing environment, so as to obtain said plaintext of said digital information within said secure processing environment.

117. The at least one computer readable storage medium of claim 113, wherein a secure video encryption key (SVEK) is stored in said secure processing environment and said media memory, wherein said instructions when executed further result in the following operations comprising:
using said SVEK in said second encryption protocol to encrypt said plaintext of said digital information within said secure processing environment to produce SVEK encrypted digital information;
transmitting said SVEK encrypted digital information to said media hardware; and
decrypting said SVEK encrypted digital information with said media hardware using said SVEK in said media memory, so as to obtain said plaintext of said digital information within said media memory.

118. The at least one computer readable storage medium of claim 117, wherein said instructions when executed further result in the following operations comprising:
generating an SVEK with said SVEK issuing authority of said client device; and
transmitting said SVEK from said SVEK issuing authority to said secure processing environment and said media hardware.

119. The at least one computer readable storage medium of claim 117, wherein said SVEK is a temporal SVEK.
